(19) United States
(12) Patent Application Publication
(10) Pub. No.: US 2025/0251647 A1
(43) Pub. Date: Aug. 7, 2025

(54) ADJUSTABLE LENS ASSEMBLY

(71) Applicant: GoPro, Inc., San Mateo, CA (US)

(72) Inventors: Ian Copeland Griggs, San Francisco, CA (US); Jonathan Michael Stern, San Mateo, CA (US); David Thomas Platner, San Francisco, CA (US); Cesar Adrian Cort, San Francisco, CA (US)

(21) Appl. No.: 19/041,240

(22) Filed: Jan. 30, 2025

Related U.S. Application Data
(60) Provisional application No. 63/627,834, filed on Feb. 1, 2024.

(51) Int. Cl. G03B 17/12

(52) U.S. Cl. CPC G03B 17/12

(57) ABSTRACT

An image capture apparatus with an image sensor and lens assembly (ISLA). The ISLA includes an image sensor, a lens mount, a lens barrel, and a lens sub-barrel. A lens mount connects the ISLA within the image capture apparatus. The lens mount extends away from the image sensor. The lens barrel is in communication with the lens mount. Barrel lenses are located within the lens barrel. The lens sub-barrel is movably connected to the lens barrel, the lens mount, or both. A sub-barrel lens is located within the lens sub-barrel.

### CROSS-REFERENCE TO RELATED APPLICATIONS

This application claims benefit of and priority to U.S. Provisional Patent Application No. 63/627,834, filed on Feb. 1, 2024, the entire disclosure of which is incorporated herein by reference in its entirety.

### TECHNICAL FIELD

This disclosure relates to an image sensor and lens assembly (ISLA) with one or more lenses with some of the lenses being movable relative to one another to adjust an air gap between the lenses.

### BACKGROUND

Image capture devices have been created with one image sensor that captures images from a direction facing the image sensor. Some image capture devices may include more than one image sensor that capture images in more than one direction. These multiple image sensors may detect image data used to generate composite images of an environment around the image capture device, such as omnidirectional images. These image sensors may be located on opposing sides of the image capture device and detected images may be combined, such as by stitching, to form a single image.

Image capture devices utilize precise lens alignment to achieve high resolution images. In modern image capture devices, a lens or series of lenses are connected to a body of a lens barrel and moved into focal alignment with an image sensor that is located within the housing of the image capture devices. Due to a variety of factors, such as manufacturing steps, material tolerances, and/or material changes during assembly, the lens or series of lenses may be seral microns or millimeters misaligned from focal alignment with the image sensor. This misalignment can negatively impact light detection and subsequent image capturing. Accordingly, what is needed are techniques to correct misalignment before image capture such that ideal focal alignment is achieved between the lens or series of lenses and the image sensor.

### SUMMARY

Disclosed herein are implementations of an image capture apparatus with an image sensor and lens assembly (ISLA). The ISLA includes an image sensor, a lens mount, a lens barrel, and a lens sub-barrel. A lens mount connecting the ISLA within the image capture apparatus. The lens mount extends away from the image sensor. The lens barrel is in communication with the lens mount. The barrel lenses are located within the lens barrel. The lens sub-barrel is movably connected to the lens barrel, the lens mount, or both. The sub-barrel lens is located within the lens sub-barrel.

The present teachings may include an image capture apparatus with an image sensor and lens assembly (ISLA). The ISLA may include an image sensor, an optical axis, a lens sub-barrel, and a lens barrel. The optical axis extends through the image sensor. The lens sub-barrel extends away from the image sensor along the optical axis. The lens barrel is located between the image sensor and the lens sub-barrel. The lens barrel extends away from the image sensor along the optical axis. Barrel lenses are located within the lens barrel. One or more sub-barrel lenses are located within the lens sub-barrel. An air gap is located between the barrel lenses and the one or more sub-barrel lenses. The air gap is adjustable by moving the lens sub-barrel along the optical axis relative to the lens barrel.

The present teachings provide a method with steps including installing barrel lenses within a lens barrel. The steps include installing one or more sub-barrel lenses within a lens sub-barrel. The steps include connecting the lens sub-barrel to the lens barrel. The steps include connecting an image sensor to the lens barrel and the lens sub-barrel. The image sensor, the lens barrel, and the lens sub-barrel are aligned along an optical axis. The steps include moving the lens sub-barrel relative to the lens barrel with respect to the optical axis to change a dimension of an air gap between the barrel lenses and the one or more sub-barrel lenses.

The present teaching provide an image capture apparatus that includes a barrel receptacle that includes an image sensor. The image capture apparatus includes a lens barrel assembly including a barrel housing connected with the barrel receptacle and a lens that overlays the image sensor. The image capture apparatus includes a mounting interface connected with the lens barrel assembly and/or the barrel receptacle and configured to axially move the lens barrel assembly towards or away from the image sensor along a z-axis so that optical alignment is achieved between the lens and the image sensor.

In some examples, the mounting interface may rotate such that the lens barrel moves up or down along the z-axis to achieve the optical alignment. The mounting interface may have a threaded connection between the lens barrel assembly and the barrel receptacle. The mounting interface may be defined at internal surfaces between the barrel lens and the barrel receptacle that are separated from the external environment by a sealant or an adhesive. The mounting interface may partially overlay the barrel housing, the lens, and the barrel receptacle. The mounting interface may be connected with the lens, and the mounting interface and the lens may move together to adjust the position of the lens barrel along the z-axis. The image capture apparatus may further include a biasing member positioned between a mounting interface flange of the lens barrel and a receptacle flange of the barrel receptacle. The biasing member may apply a force along the z-axis towards the mounting interface such that the mounting interface does not move without an external force causing rotation. The biasing member may include a spring, an elastomer, or both.

The present teachings provide for a method for aligning a lens that includes contacting a lens barrel and a barrel receptacle so that lenses of the lens barrel are aligned with an image sensor along an optical axis. The method includes simultaneously or separately conducting one or both of: curing an adhesive between a connection flange of the lens barrel and a mounting surface of the barrel receptacle, wherein the connection flange and the mounting surface both have a mounting angle relative to a base of the lens barrel; and/or rotating a mounting interface to adjust a location of the lens barrel relative to the receptacle barrel along a z-axis such that optical alignment is achieved.

In some examples, thee adhesive may be cured before rotating the mounting interface. The mounting interface may rotate such that the lens barrel moves up or down along the z-axis until the optical alignment is achieved. The mounting interface may include a threaded connection between the lens barrel and the barrel receptacle. The mounting angle may be about 5 degrees to about 90 degrees relative to the base, and the lenses may have a shrinkage value along the z-axis when the adhesive is cured that is the cosine of the mounting angle multiplied by adhesive shrinkage value. The mounting angle of the connection flange and the mounting surface may be the same.

The present teachings provide an image capture apparatus that includes a barrel receptacle including a lens mounting surface that has a mounting angle relative to a base that defines a z-axis. The image capture apparatus includes a lens barrel including a connection flange connected with the lens mounting surface and an adhesive that connects the lens mounting surface and that shrinks along the z-axis of the base of the barrel receptacle when cured.

In some examples, the lens barrel may include lenses that are optically aligned with an image sensor of the barrel receptacle along the z-axis. The mounting angle may be about 5 degrees to about 90 degrees relative to the base, and the lenses may have a shrinkage value along the z-axis when the adhesive is cured that is the cosine of the mounting angle multiplied by adhesive shrinkage value. The lens mounting surface may include at least two separate surfaces that each have mounting angles that are different. The adhesive may be cured by one or more of heat, gassing, moisture, oxygen, pressure, or any combination thereof.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1B are isometric views of an example of an image capture apparatus.

FIGS. 2A-2B are isometric views of another example of an image capture apparatus.

FIG. 3 is a top view of another example of an image capture apparatus.

FIGS. 4A-4B are isometric views of another example of an image capture apparatus.

FIG. 5 is a block diagram of electronic components of an image capture apparatus.

FIG. 6 is an isometric view of an image sensor and lens assembly (ISLA).

FIG. 7 is a cross-sectional view of the ISLA of FIG. 6 along line VII-VII.

FIG. 8A is a side view of a lens barrel and a lens sub-barrel.

FIG. 8B is a top isometric view of the lens barrel and the lens sub-barrel of FIG. 8A.

FIG. 9 is a side view of lenses and light passing through the lenses.

FIG. 10A is a side cross-sectional view of the lens barrel and the lens sub-barrel of FIG. 8A in a first position.

FIG. 10B is a side cross-sectional view of the lens barrel and the lens sub-barrel of FIG. 8A in a second position.

FIG. 11 is a graph representing an amount of shift of the light caused by movement of the lens sub-barrel.

FIG. 12 is a block diagram illustrating steps of constructing and focusing an image sensor and lens assembly (ISLA).

FIG. 13A is a perspective view of a lens assembly (ISLA).

FIGS. 13B-13C are cross-sectional views of a lens assembly (ISLA).

FIGS. 14A-14B are cross-sectional views of a lens assembly (ISLA).

FIG. 15 is a cross-sectional view of a lens assembly (ISLA).

FIG. 16A is a perspective view of a lens assembly (ISLA).

FIG. 16B is a cross-sectional view of a lens assembly (ISLA).

FIGS. 17A-17B are cross-sectional views of a lens assembly (ISLA).

FIGS. 18A-18B are cross-sectional views of a lens assembly (ISLA).

FIGS. 19A-19B are cross-sectional views of a lens assembly (ISLA).

FIGS. 20A-20B are cross-sectional views of a lens assembly (ISLA).

FIGS. 21A-21B are cross-sectional views of a lens assembly (ISLA).

### DETAILED DESCRIPTION

Cameras may be focused, aligned, or both during assembly so that clear images may be captured using such cameras. The cameras discussed herein may have an image sensor and lens assembly (ISLA) that may be axially adjustable to align light along an optical axis, relative to an image sensor, or both. The ISLA may include one or more barrels that are movable relative to one another, relative to the image sensor, or both. The barrels (e.g., the lens barrel, the lens sub-barrel) may connected directly together. One or both of the barrels may be adjusted to focus, align, or both light through the ISLA onto the image sensor. The lens barrel may include one or more barrel lenses. The lens sub-barrel may include one or more sub-barrel lenses.

An airgap may be located between a barrel lens of the one or more barrel lenses and a sub-barrel lens of the one or more sub-barrel lenses. The one or more barrel lenses may include a forward barrel lens. The one or more sub-barrel lenses may include a forward sub-barrel lens. The airgap may be located between the forward barrel lens and the forward sub-barrel lens. The airgap may be adjusted by moving the forward barrel lens (e.g., of the lens barrel) relative to the forward sub-barrel lens (e.g., of the lens sub-barrel). The lens sub-barrel may rotate about the optical axis to move the lens sub-barrel along the optical axis. The lens sub-barrel may include sub-barrel fasteners that permit a movable connection of the lens sub-barrel to be created.

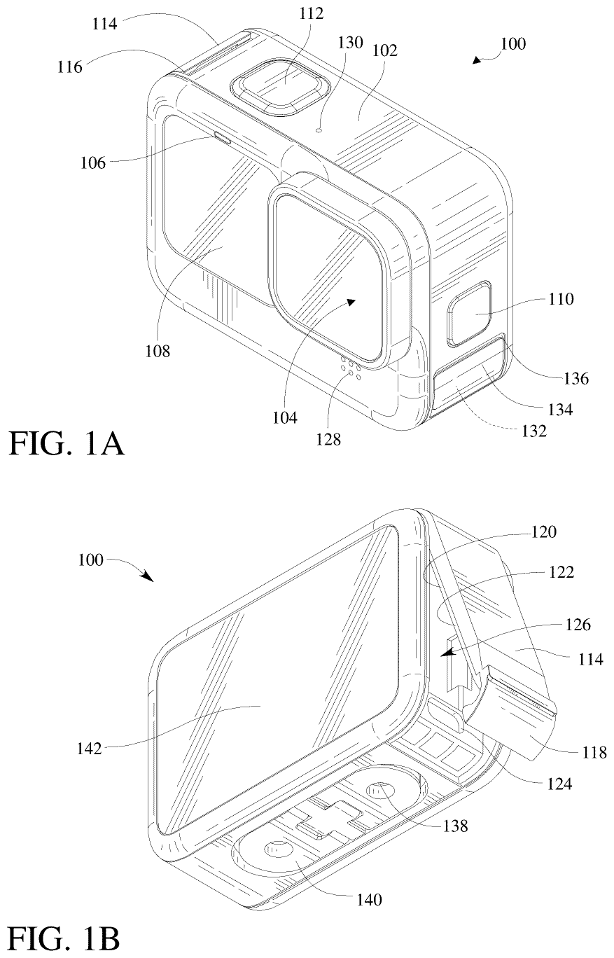

The sub-barrel fasteners may connect the lens sub-barrel to the lens barrel, the lens mount, or both (e.g., by lens mount fasteners, or by lens barrel outer fasteners). The sub-barrel fasteners may allow adjustment of the ISLA. The sub-barrel fasteners may connect the sub-barrel within the ISLA, directly to a lens barrel outer fastener, or both. The sub-barrel fasteners may be contacted with a connecting agent. The connecting agent may temporarily form a connection, permanently form a connection, removably form a connection, or a combination thereof. The connecting agent may be activated one or more times. The connecting agent may be partially activated to form a connection with a first strength. The connecting agent may be partially activated to form a connection with a second strength that is greater than the first strength. The connecting agent may be activated to form a final connection. The final connection may have a connection with a greatest strength as illustrated herein in FIGS. 1-4B.

When assembling the image capture apparatuses, the distances between the image sensors and the lenses are limited in deviations to a given tolerance (i.e., variation from an ideal optical alignment on any of the x, y, and/or z axes) before focus, field of view, and depth of view are lost or diminished when capturing images and/or detecting light. After an initial connection is made between a lens barrel (which includes one or more lenses) and a barrel receptacle (which includes the image sensor), an optical adjustment may be needed to achieve desirable optical alignment. To effect this, a mounting interface, such as a threaded connection, between the lens barrel and barrel receptacle may be utilized to move the barrel mount closer to or further from the image sensor along a z-axis. Since the mounting interface is generally a rotatable connection, the barrel mount is generally held in place with respect to the x and y-axes while moving to a desirable location along the z-axis before achieving optical alignment. Once optical alignment is achieved, the mounting interface can be locked through any fixed connection, such as adhesive or screws.

Similarly, when a lens mount is used over a lens, the lens mount can be used to adjust the distance between two lenses such that focus, field of view, and depth of view issues are reduced or eliminated. The lens mount can be moved by a similar mounting interface between the lens mount and the lens barrel such that the external lens moves along a z-axis with the mounting interface. In combination or alternatively, an adhesive may be used between two of the lenses, and the lenses may be adjusted relative to each other so that alignment is achieved along all the x, y, and z-axes, before curing of the adhesive.

When using adhesives, shrinkage can occur during curing, such as by chemical reaction and release of chemicals (e.g., gases) or a change in chemical properties in the cured adhesive, as described herein. When cured on a normal surface and gravity influences shrinkage, two components (such as a lens and a barrel mount) may move closer together. To minimize shrinkage, the present disclosure provides for mounting surfaces that use angles and known shrinkage values to minimize the shrinkage that occurs during cure, which then subsequently utilizes less or no adjustments along the z-axis relative to the image sensor to achieve optical alignment. These techniques could apply to any of the image capture apparatuses of FIGS. 1A-4.

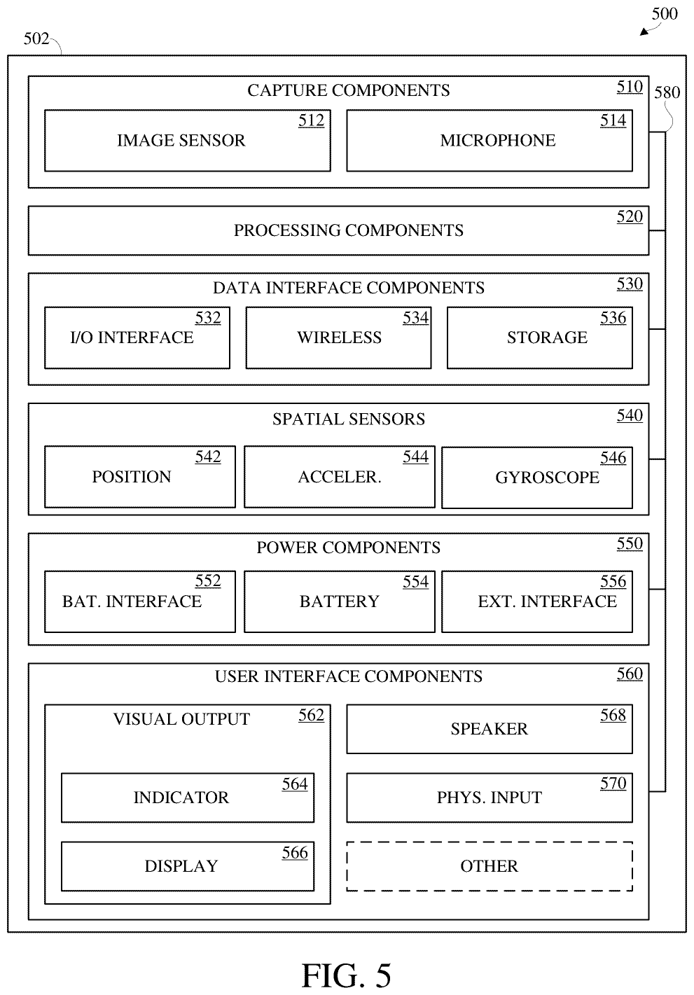

FIGS. 1A-1B are isometric views of an example of an image capture apparatus 100. The image capture apparatus 100 includes a body 102, an image capture device 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, 132, a speaker 138, an interconnect mechanism 140, and a display 142. Although not expressly shown in FIGS. 1A-1B, the image capture apparatus 100 includes internal electronics, such as imaging electronics, power electronics, and the like, internal to the body 102 for capturing images and performing other functions of the image capture apparatus 100. An example showing internal electronics is shown in FIG. 5. The arrangement of the components of the image capture apparatus 100 shown in FIGS. 1A-1B is an example, other arrangements of elements may be used, except as is described herein or as is otherwise clear from context.

The body 102 of the image capture apparatus 100 may be made of a rigid material such as plastic, aluminum, steel, or fiberglass. Other materials may be used. The image capture device 104 is structured on a front surface of, and within, the body 102. The image capture device 104 includes a lens. The lens of the image capture device 104 receives light incident upon the lens of the image capture device 104 and directs the received light onto an image sensor of the image capture device 104 internal to the body 102. The image capture apparatus 100 may capture one or more images, such as a sequence of images, such as video. The image capture apparatus 100 may store the captured images and video for subsequent display, playback, or transfer to an external device. Although one image capture device 104 is shown in FIG. 1A, the image capture apparatus 100 may include multiple image capture devices, which may be structured on respective surfaces of the body 102.

As shown in FIG. 1A, the image capture apparatus 100 includes the indicator 106 structured on the front surface of the body 102. The indicator 106 may output, or emit, visible light, such as to indicate a status of the image capture apparatus 100. For example, the indicator 106 may be a light-emitting diode (LED). Although one indicator 106 is shown in FIG. 1A, the image capture apparatus 100 may include multiple indictors structured on respective surfaces of the body 102.

As shown in FIG. 1A, the image capture apparatus 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture apparatus 100. In some implementations, the display 108 may be omitted or combined with another component of the image capture apparatus 100.

As shown in FIG. 1A, the image capture apparatus 100 includes the mode button 110 structured on a side surface of the body 102. Although described as a button, the mode button 110 may be another type of input device, such as a switch, a toggle, a slider, or a dial. Although one mode button 110 is shown in FIG. 1A, the image capture apparatus 100 may include multiple mode, or configuration, buttons structured on respective surfaces of the body 102. In some implementations, the mode button 110 may be omitted or combined with another component of the image capture apparatus 100. For example, the display 108 may be an interactive, such as touchscreen, display, and the mode button 110 may be physically omitted and functionally combined with the display 108.

As shown in FIG. 1A, the image capture apparatus 100 includes the shutter button 112 structured on a top surface of the body 102. The shutter button 112 may be another type of input device, such as a switch, a toggle, a slider, or a dial. The image capture apparatus 100 may include multiple shutter buttons structured on respective surfaces of the body 102. In some implementations, the shutter button 112 may be omitted or combined with another component of the image capture apparatus 100.

The mode button 110, the shutter button 112, or both, obtain input data, such as user input data in accordance with user interaction with the image capture apparatus 100. For example, the mode button 110, the shutter button 112, or both, may be used to turn the image capture apparatus 100 on and off, scroll through modes and settings, and select modes and change settings.

As shown in FIG. 1B, the image capture apparatus 100 includes the door 114 coupled to the body 102, such as using the hinge mechanism 116 (FIG. 1A). The door 114 may be secured to the body 102 using the latch mechanism 118 that releasably engages the body 102 at a position generally opposite the hinge mechanism 116. The door 114 includes the seal 120 and the battery interface 122. Although one door 114 is shown in FIG. 1A, the image capture apparatus 100 may include multiple doors respectively forming respective surfaces of the body 102, or portions thereof. The door 114 may be removable from the body 102 by releasing the latch mechanism 118 from the body 102 and decoupling the hinge mechanism 116 from the body 102.

In FIG. 1B, the door 114 is shown in a partially open position such that the data interface 124 is accessible for communicating with external devices and the battery receptacle 126 is accessible for placement or replacement of a battery. In FIG. 1A, the door 114 is shown in a closed position. In implementations in which the door 114 is in the closed position, the seal 120 engages a flange (not shown) to provide an environmental seal and the battery interface 122 engages the battery (not shown) to secure the battery in the battery receptacle 126.

As shown in FIG. 1B, the image capture apparatus 100 includes the battery receptacle 126 structured to form a portion of an interior surface of the body 102. The battery receptacle 126 includes operative connections for power transfer between the battery and the image capture apparatus 100. In some implementations, the battery receptacle 126 may be omitted. The image capture apparatus 100 may include multiple battery receptacles.

As shown in FIG. 1A, the image capture apparatus 100 includes a first microphone 128 structured on a front surface of the body 102, a second microphone 130 structured on a top surface of the body 102, and a third microphone 132 structured on a side surface of the body 102. The third microphone 132, which may be referred to as a drain microphone and is indicated as hidden in dotted line, is located behind a drain cover 134, surrounded by a drain channel 136, and can drain liquid from audio components of the image capture apparatus 100. The image capture apparatus 100 may include other microphones on other surfaces of the body 102. The microphones 128, 130, 132 receive and record audio, such as in conjunction with capturing video or separate from capturing video. In some implementations, one or more of the microphones 128, 130, 132 may be omitted or combined with other components of the image capture apparatus 100.

As shown in FIG. 1B, the image capture apparatus 100 includes the speaker 138 structured on a bottom surface of the body 102. The speaker 138 outputs or presents audio, such as by playing back recorded audio or emitting sounds associated with notifications. The image capture apparatus 100 may include multiple speakers structured on respective surfaces of the body 102.

As shown in FIG. 1B, the image capture apparatus 100 includes the interconnect mechanism 140 structured on a bottom surface of the body 102. The interconnect mechanism 140 removably connects the image capture apparatus 100 to an external structure, such as a handle grip, another mount, or a securing device. The interconnect mechanism 140 includes folding protrusions configured to move between a nested or collapsed position as shown in FIG. 1B and an extended or open position. The folding protrusions of the interconnect mechanism 140 in the extended or open position may be coupled to reciprocal protrusions of other devices such as handle grips, mounts, clips, or like devices. The image capture apparatus 100 may include multiple interconnect mechanisms structured on, or forming a portion of, respective surfaces of the body 102. In some implementations, the interconnect mechanism 140 may be omitted.

As shown in FIG. 1B, the image capture apparatus 100 includes the display 142 structured on, and forming a portion of, a rear surface of the body 102. The display 142 outputs, such as presents or displays, such as by emitting visible light, data, such as to show image information such as image previews, live video capture, or status information such as battery life, camera mode, elapsed time, and the like. In some implementations, the display 142 may be an interactive display, which may receive, detect, or capture input, such as user input representing user interaction with the image capture apparatus 100. The image capture apparatus 100 may include multiple displays structured on respective surfaces of the body 102, such as the displays 108, 142 shown in FIGS. 1A-1B. In some implementations, the display 142 may be omitted or combined with another component of the image capture apparatus 100.

The image capture apparatus 100 may include features or components other than those described herein, such as other buttons or interface features. In some implementations, interchangeable lenses, cold shoes, and hot shoes, or a combination thereof, may be coupled to or combined with the image capture apparatus 100. For example, the image capture apparatus 100 may communicate with an external device, such as an external user interface device, via a wired or wireless computing communication link, such as via the data interface 124. The computing communication link may be a direct computing communication link or an indirect computing communication link, such as a link including another device or a network, such as the Internet. The image capture apparatus 100 may transmit images to the external device via the computing communication link.

The external device may store, process, display, or combination thereof, the images. The external user interface device may be a computing device, such as a smartphone, a tablet computer, a smart watch, a portable computer, personal computing device, or another device or combination of devices configured to receive user input, communicate information with the image capture apparatus 100 via the computing communication link, or receive user input and communicate information with the image capture apparatus 100 via the computing communication link. The external user interface device may implement or execute one or more applications to manage or control the image capture apparatus 100. For example, the external user interface device may include an application for controlling camera configuration, video acquisition, video display, or any other configurable or controllable aspect of the image capture apparatus 100. In some implementations, the external user interface device may generate and share, such as via a cloud-based or social media service, one or more images or video clips. In some implementations, the external user interface device may display unprocessed or minimally processed images or video captured by the image capture apparatus 100 contemporaneously with capturing the images or video by the image capture apparatus 100, such as for shot framing or live preview.

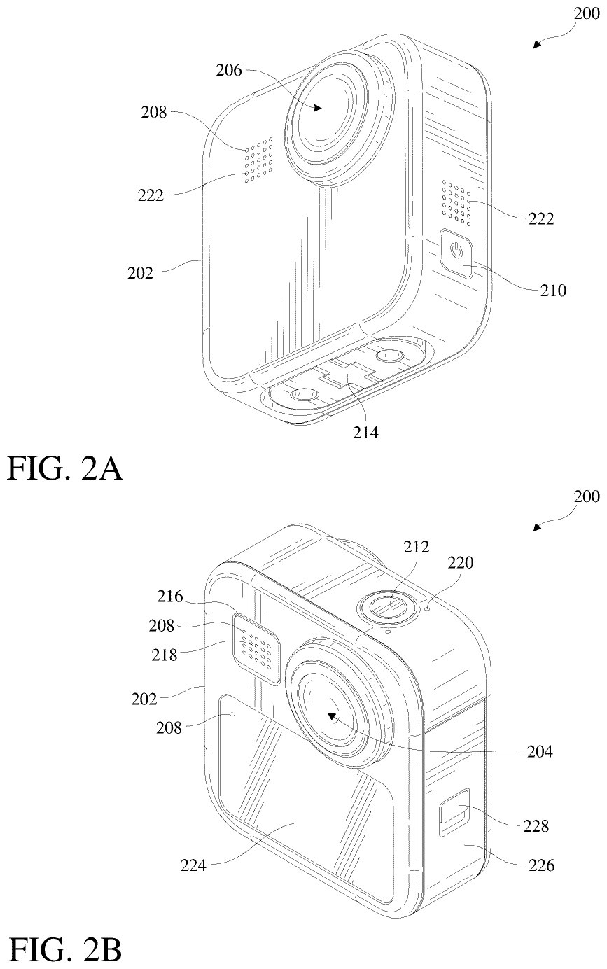

FIGS. 2A-2B illustrate another example of an image capture apparatus 200. The image capture apparatus 200 is similar to the image capture apparatus 100 shown in FIGS. 1A-1B. The image capture apparatus 200 includes a body 202, a first image capture device 204, a second image capture device 206, indicators 208, a mode button 210, a shutter button 212, an interconnect mechanism 214, a drainage channel 216, audio components 218, 220, 222, a display 224, and a door 226 including a release mechanism 228. The arrangement of the components of the image capture apparatus 200 shown in FIGS. 2A-2B is an example, other arrangements of elements may be used.

The body 202 of the image capture apparatus 200 may be similar to the body 102 shown in FIGS. 1A-1B. The first image capture device 204 is structured on a front surface of the body 202. The first image capture device 204 includes a first lens. The first image capture device 204 may be similar to the image capture device 104 shown in FIG. 1A. As shown in FIG. 2A, the image capture apparatus 200 includes the second image capture device 206 structured on a rear surface of the body 202. The second image capture device 206 includes a second lens. The second image capture device 206 may be similar to the image capture device 104 shown in FIG. 1A. The image capture devices 204, 206 are disposed on opposing surfaces of the body 202, for example, in a back-to-back configuration, Janus configuration, or offset Janus configuration. The image capture apparatus 200 may include other image capture devices structured on respective surfaces of the body 202.

As shown in FIG. 2B, the image capture apparatus 200 includes the indicators 208 associated with the audio component 218 and the display 224 on the front surface of the body 202. The indicators 208 may be similar to the indicator 106 shown in FIG. 1A. For example, one of the indicators 208 may indicate a status of the first image capture device 204 and another one of the indicators 208 may indicate a status of the second image capture device 206. Although two indicators 208 are shown in FIGS. 2A-2B, the image capture apparatus 200 may include other indictors structured on respective surfaces of the body 202.

As shown in FIGS. 2A-2B, the image capture apparatus 200 includes input mechanisms including the mode button 210, structured on a side surface of the body 202, and the shutter button 212, structured on a top surface of the body 202. The mode button 210 may be similar to the mode button 110 shown in FIG. 1B. The shutter button 212 may be similar to the shutter button 112 shown in FIG. 1A.

The image capture apparatus 200 includes internal electronics (not expressly shown), such as imaging electronics, power electronics, and the like, internal to the body 202 for capturing images and performing other functions of the image capture apparatus 200. An example showing internal electronics is shown in FIG. 5.

As shown in FIGS. 2A-2B, the image capture apparatus 200 includes the interconnect mechanism 214 structured on a bottom surface of the body 202. The interconnect mechanism 214 may be similar to the interconnect mechanism 140 shown in FIG. 1B.

As shown in FIG. 2B, the image capture apparatus 200 includes the drainage channel 216 for draining liquid from audio components of the image capture apparatus 200.

As shown in FIGS. 2A-2B, the image capture apparatus 200 includes the audio components 218, 220, 222, respectively structured on respective surfaces of the body 202. The audio components 218, 220, 222 may be similar to the microphones 128, 130, 132 and the speaker 138 shown in FIGS. 1A-1B. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts.

As shown in FIGS. 2A-2B, a first audio component 218 is located on a front surface of the body 202, a second audio component 220 is located on a top surface of the body 202, and a third audio component 222 is located on a back surface of the body 202. Other numbers and configurations for the audio components 218, 220, 222 may be used. For example, the audio component 218 may be a drain microphone surrounded by the drainage channel 216 and adjacent to one of the indicators 208 as shown in FIG. 2B.

As shown in FIG. 2B, the image capture apparatus 200 includes the display 224 structured on a front surface of the body 202. The display 224 may be similar to the displays 108, 142 shown in FIGS. 1A-1B. The display 224 may include an I/O interface. The display 224 may include one or more of the indicators 208. The display 224 may receive touch inputs. The display 224 may display image information during video capture. The display 224 may provide status information to a user, such as status information indicating battery power level, memory card capacity, time elapsed for a recorded video, etc. The image capture apparatus 200 may include multiple displays structured on respective surfaces of the body 202. In some implementations, the display 224 may be omitted or combined with another component of the image capture apparatus 200.

As shown in FIG. 2B, the image capture apparatus 200 includes the door 226 structured on, or forming a portion of, the side surface of the body 202. The door 226 may be similar to the door 114 shown in FIG. 1A. For example, the door 226 shown in FIG. 2A includes a release mechanism 228. The release mechanism 228 may include a latch, a button, or other mechanism configured to receive a user input that allows the door 226 to change position. The release mechanism 228 may be used to open the door 226 for a user to access a battery, a battery receptacle, an I/O interface, a memory card interface, etc.

In some embodiments, the image capture apparatus 200 may include features or components other than those described herein, some features or components described herein may be omitted, or some features or components described herein may be combined. For example, the image capture apparatus 200 may include additional interfaces or different interface features, interchangeable lenses, cold shoes, or hot shoes.

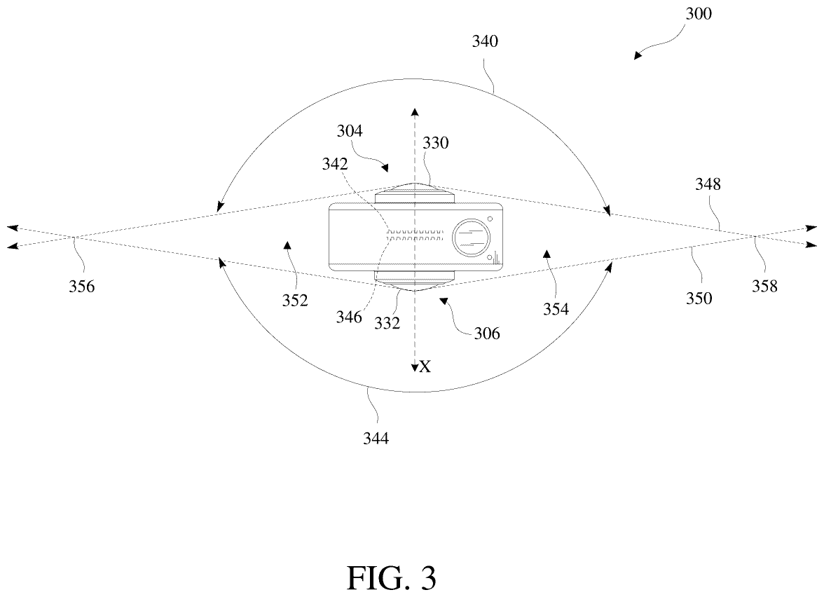

FIG. 3 is a top view of an image capture apparatus 300. The image capture apparatus 300 is similar to the image capture apparatus 200 of FIGS. 2A-2B and is configured to capture spherical images.

As shown in FIG. 3, a first image capture device 304 includes a first lens 330 and a second image capture device 306 includes a second lens 332. For example, the first image capture device 304 may capture a first image, such as a first hemispheric, or hyper-hemispherical, image, the second image capture device 306 may capture a second image, such as a second hemispheric, or hyper-hemispherical, image, and the image capture apparatus 300 may generate a spherical image incorporating or combining the first image and the second image, which may be captured concurrently, or substantially concurrently.

The first image capture device 304 defines a first field-of-view 340 wherein the first lens 330 of the first image capture device 304 receives light. The first lens 330 directs the received light corresponding to the first field-of-view 340 onto a first image sensor 342 of the first image capture device 304. For example, the first image capture device 304 may include a first lens barrel (not expressly shown), extending from the first lens 330 to the first image sensor 342.

The second image capture device 306 defines a second field-of-view 344 wherein the second lens 332 receives light. The second lens 332 directs the received light corresponding to the second field-of-view 344 onto a second image sensor 346 of the second image capture device 306. For example, the second image capture device 306 may include a second lens barrel (not expressly shown), extending from the second lens 332 to the second image sensor 346.

A boundary 348 of the first field-of-view 340 is shown using broken directional lines. A boundary 350 of the second field-of-view 344 is shown using broken directional lines. As shown, the image capture devices 304, 306 are arranged in a back-to-back (Janus) configuration such that the lenses 330, 332 face in opposite directions, and such that the image capture apparatus 300 may capture spherical images. The first image sensor 342 captures a first hyper-hemispherical image plane from light entering the first lens 330. The second image sensor 346 captures a second hyper-hemispherical image plane from light entering the second lens 332.

As shown in FIG. 3, the fields-of-view 340, 344 partially overlap such that the combination of the fields-of-view 340, 344 forms a spherical field-of-view, except that one or more uncaptured areas 352, 354 may be outside of the fields-of-view 340, 344 of the lenses 330, 332. Light emanating from or passing through the uncaptured areas 352, 354, which may be proximal to the image capture apparatus 300, may be obscured from the lenses 330, 332 and the corresponding image sensors 342, 346, such that content corresponding to the uncaptured areas 352, 354 may be omitted from images captured by the image capture apparatus 300. In some implementations, the image capture devices 304, 306, or the lenses 330, 332 thereof, may be configured to minimize the uncaptured areas 352, 354.

Examples of points of transition, or overlap points, from the uncaptured areas 352, 354 to the overlapping portions of the fields-of-view 340, 344 are shown at 356, 358.

Images contemporaneously captured by the respective image sensors 342, 346 may be combined to form a combined image, such as a spherical image. Generating a combined image may include correlating the overlapping regions captured by the respective image sensors 342, 346, aligning the captured fields-of-view 340, 344, and stitching the images together to form a cohesive combined image. Stitching the images together may include correlating the overlap points 356, 358 with respective locations in corresponding images captured by the image sensors 342, 346. Although a planar view of the fields-of-view 340, 344 is shown in FIG. 3, the fields-of-view 340, 344 are hyper-hemispherical.

A change in the alignment, such as position, tilt, or a combination thereof, of the image capture devices 304, 306, such as of the lenses 330, 332, the image sensors 342, 346, or both, may change the relative positions of the respective fields-of-view 340, 344, may change the locations of the overlap points 356, 358, such as with respect to images captured by the image sensors 342, 346, and may change the uncaptured areas 352, 354, which may include changing the uncaptured areas 352, 354 unequally.

Incomplete or inaccurate information indicating the alignment of the image capture devices 304, 306, such as the locations of the overlap points 356, 358, may decrease the accuracy, efficiency, or both of generating a combined image. In some implementations, the image capture apparatus 300 may maintain information indicating the location and orientation of the image capture devices 304, 306, such as of the lenses 330, 332, the image sensors 342, 346, or both, such that the fields-of-view 340, 344, the overlap points 356, 358, or both may be accurately determined, which may improve the accuracy, efficiency, or both of generating a combined image.

The lenses 330, 332 may be aligned along an axis X as shown, laterally offset from each other (not shown), off-center from a central axis of the image capture apparatus 300 (not shown), or laterally offset and off-center from the central axis (not shown). Whether through use of offset or through use of compact image capture devices 304, 306, a reduction in distance between the lenses 330, 332 along the axis X may improve the overlap in the fields-of-view 340, 344, such as by reducing the uncaptured areas 352, 354.

Images or frames captured by the image capture devices 304, 306 may be combined, merged, or stitched together to produce a combined image, such as a spherical or panoramic image, which may be an equirectangular planar image. In some implementations, generating a combined image may include use of techniques such as noise reduction, tone mapping, white balancing, or other image correction. In some implementations, pixels along a stitch boundary, which may correspond with the overlap points 356, 358, may be matched accurately to minimize boundary discontinuities.

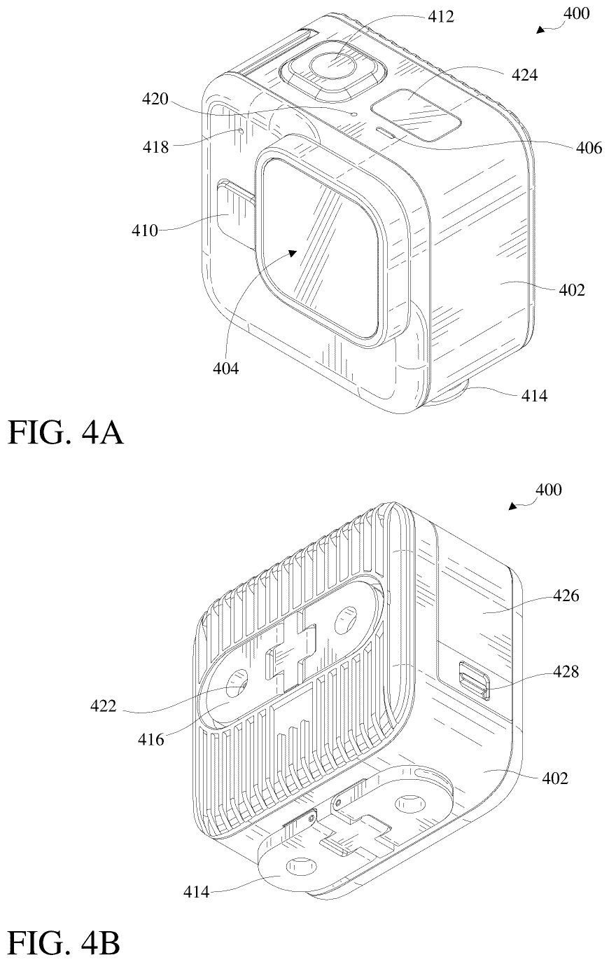

FIGS. 4A-4B illustrate another example of an image capture apparatus 400. The image capture apparatus 400 is similar to the image capture apparatus 100 shown in FIGS. 1A-1B and to the image capture apparatus 200 shown in FIGS. 2A-2B. The image capture apparatus 400 includes a body 402, an image capture device 404, an indicator 406, a mode button 410, a shutter button 412, interconnect mechanisms 414, 416, audio components 418, 420, 422, a display 424, and a door 426 including a release mechanism 428. The arrangement of the components of the image capture apparatus 400 shown in FIGS. 4A-4B is an example, other arrangements of elements may be used.

The body 402 of the image capture apparatus 400 may be similar to the body 102 shown in FIGS. 1A-1B. The image capture device 404 is structured on a front surface of the body 402. The image capture device 404 includes a lens and may be similar to the image capture device 104 shown in FIG. 1A.

As shown in FIG. 4A, the image capture apparatus 400 includes the indicator 406 on a top surface of the body 402. The indicator 406 may be similar to the indicator 106 shown in FIG. 1A. The indicator 406 may indicate a status of the image capture device 204. Although one indicator 406 is shown in FIGS. 4A, the image capture apparatus 400 may include other indictors structured on respective surfaces of the body 402.

As shown in FIGS. 4A, the image capture apparatus 400 includes input mechanisms including the mode button 410, structured on a front surface of the body 402, and the shutter button 412, structured on a top surface of the body 402. The mode button 410 may be similar to the mode button 110 shown in FIG. 1B. The shutter button 412 may be similar to the shutter button 112 shown in FIG. 1A.

The image capture apparatus 400 includes internal electronics (not expressly shown), such as imaging electronics, power electronics, and the like, internal to the body 402 for capturing images and performing other functions of the image capture apparatus 400. An example showing internal electronics is shown in FIG. 5.

As shown in FIGS. 4A-4B, the image capture apparatus 400 includes the interconnect mechanisms 414, 416, with a first interconnect mechanism 414 structured on a bottom surface of the body 402 and a second interconnect mechanism 416 disposed within a rear surface of the body 402. The interconnect mechanisms 414, 416 may be similar to the interconnect mechanism 140 shown in FIG. 1B and the interconnect mechanism 214 shown in FIG. 2A.

As shown in FIGS. 4A-4B, the image capture apparatus 400 includes the audio components 418, 420, 422 respectively structured on respective surfaces of the body 402. The audio components 418, 420, 422 may be similar to the microphones 128, 130, 132 and the speaker 138 shown in FIGS. 1A-1B. One or more of the audio components 418, 420, 422 may be, or may include, audio sensors, such as microphones, to receive and record audio signals, such as voice commands or other audio, in conjunction with capturing images or video. One or more of the audio components 418, 420, 422 may be, or may include, an audio presentation component that may present, or play, audio, such as to provide notifications or alerts.

As shown in FIGS. 4A-4B, a first audio component 418 is located on a front surface of the body 402, a second audio component 420 is located on a top surface of the body 402, and a third audio component 422 is located on a rear surface of the body 402. Other numbers and configurations for the audio components 418, 420, 422 may be used.

As shown in FIG. 4A, the image capture apparatus 400 includes the display 424 structured on a front surface of the body 402. The display 424 may be similar to the displays 108, 142 shown in FIGS. 1A-1B. The display 424 may include an I/O interface. The display 424 may receive touch inputs. The display 424 may display image information during video capture. The display 424 may provide status information to a user, such as status information indicating battery power level, memory card capacity, time elapsed for a recorded video, etc. The image capture apparatus 400 may include multiple displays structured on respective surfaces of the body 402. In some implementations, the display 424 may be omitted or combined with another component of the image capture apparatus 200.

As shown in FIG. 4B, the image capture apparatus 400 includes the door 426 structured on, or forming a portion of, the side surface of the body 402. The door 426 may be similar to the door 226 shown in FIG. 2B. The door 426 shown in FIG. 4B includes the release mechanism 428. The release mechanism 428 may include a latch, a button, or other mechanism configured to receive a user input that allows the door 426 to change position. The release mechanism 428 may be used to open the door 426 for a user to access a battery, a battery receptacle, an I/O interface, a memory card interface, etc.

In some embodiments, the image capture apparatus 400 may include features or components other than those described herein, some features or components described herein may be omitted, or some features or components described herein may be combined. For example, the image capture apparatus 400 may include additional interfaces or different interface features, interchangeable lenses, cold shoes, or hot shoes.

FIG. 5 is a block diagram of electronic components in an image capture apparatus 500. The image capture apparatus 500 may be a single-lens image capture device, a multi-lens image capture device, or variations thereof, including an image capture apparatus with multiple capabilities such as the use of interchangeable image sensor lens assemblies. Components, such as electronic components, of the image capture apparatus 100 shown in FIGS. 1A-1B, the image capture apparatus 200 shown in FIGS. 2A-2B, the image capture apparatus 300 shown in FIG. 3, or the image capture apparatus 400 shown in FIGS. 4A-4B, may be implemented as shown in FIG. 5.

The image capture apparatus 500 includes a body 502. The body 502 may be similar to the body 102 shown in FIGS. 1A-1B, the body 202 shown in FIGS. 2A-2B, or the body 402 shown in FIGS. 4A-4B. The body 502 includes electronic components such as capture components 510, processing components 520, data interface components 530, spatial sensors 540, power components 550, user interface components 560, and a bus 580.

The capture components 510 include an image sensor 512 for capturing images. Although one of the image sensor 512 is shown in FIG. 5, the capture components 510 may include multiple image sensors. The image sensor 512 may be similar to the image sensors 342, 346 shown in FIG. 3. The image sensor 512 may be, for example, a charge-coupled device (CCD) sensor, an active pixel sensor (APS), a complementary metal-oxide-semiconductor (CMOS) sensor, or an N-type metal-oxide-semiconductor (NMOS) sensor. The image sensor 512 detects light, such as within a defined spectrum, such as the visible light spectrum or the infrared spectrum, incident through a corresponding lens such as the first lens 330 with respect to the first image sensor 342 or the second lens 332 with respect to the second image sensor 346 as shown in FIG. 3. The image sensor 512 captures detected light as image data and conveys the captured image data as electrical signals (image signals or image data) to the other components of the image capture apparatus 500, such as to the processing components 520, such as via the bus 580.

The capture components 510 include a microphone 514 for capturing audio. Although one microphone 514 is shown in FIG. 5, the capture components 510 may include multiple microphones. The microphone 514 detects and captures, or records, sound, such as sound waves incident upon the microphone 514. The microphone 514 may detect, capture, or record sound in conjunction with capturing images by the image sensor 512. The microphone 514 may detect sound to receive audible commands to control the image capture apparatus 500. The microphone 514 may be similar to the microphones 128, 130, 132 shown in FIGS. 1A-1B, the audio components 218, 220, 222 shown in FIGS. 2A-2B, or the audio components 418, 420, 422 shown in FIGS. 4A-4B.

The processing components 520 perform image signal processing, such as filtering, tone mapping, or stitching, to generate, or obtain, processed images, or processed image data, based on image data obtained from the image sensor 512. The processing components 520 may include one or more processors having single or multiple processing cores. In some implementations, the processing components 520 may include, or may be, an application specific integrated circuit (ASIC) or a digital signal processor (DSP). For example, the processing components 520 may include a custom image signal processor. The processing components 520 conveys data, such as processed image data, with other components of the image capture apparatus 500 via the bus 580. In some implementations, the processing components 520 may include an encoder, such as an image or video encoder that may encode, decode, or both, the image data, such as for compression coding, transcoding, or a combination thereof.

Although not shown expressly in FIG. 5, the processing components 520 may include memory, such as a random-access memory (RAM) device, which may be non-transitory computer-readable memory. The memory of the processing components 520 may include executable instructions and data that can be accessed by the processing components 520.

The data interface components 530 communicates with other, such as external, electronic devices, such as a remote control, a smartphone, a tablet computer, a laptop computer, a desktop computer, or an external computer storage device. For example, the data interface components 530 may receive commands to operate the image capture apparatus 500. In another example, the data interface components 530 may transmit image data to transfer the image data to other electronic devices. The data interface components 530 may be configured for wired communication, wireless communication, or both. As shown, the data interface components 530 include an I/O interface 532, a wireless data interface 534, and a storage interface 536. In some implementations, one or more of the I/O interface 532, the wireless data interface 534, or the storage interface 536 may be omitted or combined.

The I/O interface 532 may send, receive, or both, wired electronic communications signals. For example, the I/O interface 532 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 532 is shown in FIG. 5, the data interface components 530 include multiple I/O interfaces. The I/O interface 532 may be similar to the data interface 124 shown in FIG. 1B.

The wireless data interface 534 may send, receive, or both, wireless electronic communications signals. The wireless data interface 534 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 534 is shown in FIG. 5, the data interface components 530 include multiple wireless data interfaces. The wireless data interface 534 may be similar to the data interface 124 shown in FIG. 1B.

The storage interface 536 may include a memory card connector, such as a memory card receptacle, configured to receive and operatively couple to a removable storage device, such as a memory card, and to transfer, such as read, write, or both, data between the image capture apparatus 500 and the memory card, such as for storing images, recorded audio, or both captured by the image capture apparatus 500 on the memory card. Although one storage interface 536 is shown in FIG. 5, the data interface components 530 include multiple storage interfaces. The storage interface 536 may be similar to the data interface 124 shown in FIG. 1B.

The spatial, or spatiotemporal, sensors 540 detect the spatial position, movement, or both, of the image capture apparatus 500. As shown in FIG. 5, the spatial sensors 540 include a position sensor 542, an accelerometer 544, and a gyroscope 546. The position sensor 542, which may be a global positioning system (GPS) sensor, may determine a geospatial position of the image capture apparatus 500, which may include obtaining, such as by receiving, temporal data, such as via a GPS signal. The accelerometer 544, which may be a three-axis accelerometer, may measure linear motion, linear acceleration, or both of the image capture apparatus 500. The gyroscope 546, which may be a three-axis gyroscope, may measure rotational motion, such as a rate of rotation, of the image capture apparatus 500. In some implementations, the spatial sensors 540 may include other types of spatial sensors. In some implementations, one or more of the position sensor 542, the accelerometer 544, and the gyroscope 546 may be omitted or combined.

The power components 550 distribute electrical power to the components of the image capture apparatus 500 for operating the image capture apparatus 500. As shown in FIG. 5, the power components 550 include a battery interface 552, a battery 554, and an external power interface 556 (ext. interface). The battery interface 552 (bat. interface) operatively couples to the battery 554, such as via conductive contacts to transfer power from the battery 554 to the other electronic components of the image capture apparatus 500. The battery interface 552 may be similar to the battery receptacle 126 shown in FIG. 1B. The external power interface 556 obtains or receives power from an external source, such as a wall plug or external battery, and distributes the power to the components of the image capture apparatus 500, which may include distributing power to the battery 554 via the battery interface 552 to charge the battery 554. Although one battery interface 552, one battery 554, and one external power interface 556 are shown in FIG. 5, any number of battery interfaces, batteries, and external power interfaces may be used. In some implementations, one or more of the battery interface 552, the battery 554, and the external power interface 556 may be omitted or combined. For example, in some implementations, the external interface 556 and the I/O interface 532 may be combined.

The user interface components 560 receive input, such as user input, from a user of the image capture apparatus 500, output, such as display or present, information to a user, or both receive input and output information, such as in accordance with user interaction with the image capture apparatus 500.

As shown in FIG. 5, the user interface components 560 include visual output components 562 to visually communicate information, such as to present captured images. As shown, the visual output components 562 include an indicator 564 and a display 566. The indicator 564 may be similar to the indicator 106 shown in FIG. 1A, the indicators 208 shown in FIGS. 2A-2B, or the indicator 406 shown in FIG. 4A. The display 566 may be similar to the display 108 shown in FIG. 1A, the display 142 shown in FIG. 1B, the display 224 shown in FIG. 2B, or the display 424 shown in FIG. 4A. Although the visual output components 562 are shown in FIG. 5 as including one indicator 564, the visual output components 562 may include multiple indicators. Although the visual output components 562 are shown in FIG. 5 as including one display 566, the visual output components 562 may include multiple displays. In some implementations, one or more of the indicator 564 or the display 566 may be omitted or combined.

As shown in FIG. 5, the user interface components 560 include a speaker 568. The speaker 568 may be similar to the speaker 138 shown in FIG. 1B, the audio components 218, 220, 222 shown in FIGS. 2A-2B, or the audio components 418, 420, 422 shown in FIGS. 4A-4B. Although one speaker 568 is shown in FIG. 5, the user interface components 560 may include multiple speakers. In some implementations, the speaker 568 may be omitted or combined with another component of the image capture apparatus 500, such as the microphone 514.

As shown in FIG. 5, the user interface components 560 include a physical input interface 570. The physical input interface 570 may be similar to the mode buttons 110, 210, 410 shown in FIGS. 1A, 2A, and 4A or the shutter buttons 112, 212, 412 shown in FIGS. 1A, 2B, and 4A. Although one physical input interface 570 is shown in FIG. 5, the user interface components 560 may include multiple physical input interfaces. In some implementations, the physical input interface 570 may be omitted or combined with another component of the image capture apparatus 500. The physical input interface 570 may be, for example, a button, a toggle, a switch, a dial, or a slider.

As shown in FIG. 5, the user interface components 560 include a broken line border box labeled “other” to indicate that components of the image capture apparatus 500 other than the components expressly shown as included in the user interface components 560 may be user interface components. For example, the microphone 514 may receive, or capture, and process audio signals to obtain input data, such as user input data corresponding to voice commands. In another example, the image sensor 512 may receive, or capture, and process image data to obtain input data, such as user input data corresponding to visible gesture commands. In another example, one or more of the spatial sensors 540, such as a combination of the accelerometer 544 and the gyroscope 546, may receive, or capture, and process motion data to obtain input data, such as user input data corresponding to motion gesture commands.

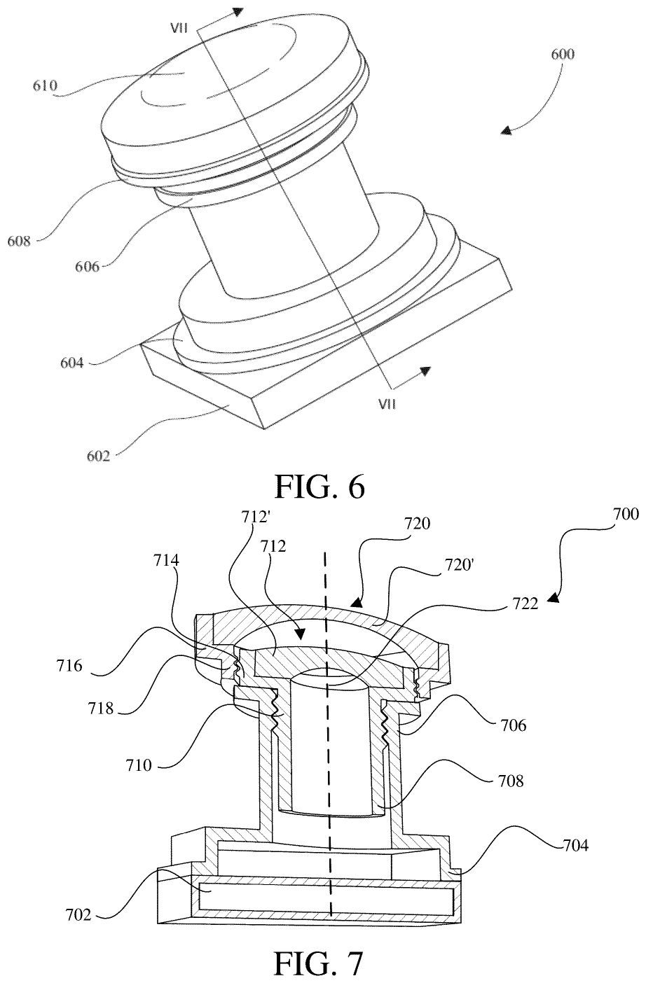

FIG. 6 is an isometric view of an image sensor and lens assembly (ISLA) 600. The ISLA 600, when installed within an image capture apparatus such as the image capture apparatus 100, 200, 300, 400, or 500, directs light onto an image sensor 602 so that images may be captured. The image capture apparatus, such as the image capture apparatus 300 shown in FIGS. 3A-3C may include more than one ISLA 600 so that more than one image may be captured by the ISLAs 600 simultaneously.

The image sensor 602 is located at an end of the ISLA 600 and captures images that are directed through the ISLA 600. The image sensor 602 may capture and store images, videos, or both. The image sensor 602 may be connected to the ISLA 600 by a lens mount 604.

The lens mount 604 may connect the ISLA 600 within an image capture apparatus. The lens mount 604 may be free of a connection with an image capture apparatus. The lens mount 604 may connect to the image capture apparatus via some other part of the ISLA 600 (e.g., so the ISLA 600 is indirectly connected to the image capture apparatus). The lens mount 604 may have a rear end that is connected to the image sensor 602 or receives all or a portion of the image sensor 602 therein. The lens mount 604 may receive one or more lens barrels 606.

A lens barrel 606 may extend into the lens mount 604 from an end of the lens mount 604 that is opposite the end coupled to the image sensor 602. The lens barrel 606 may retain one or more lenses therein. The lens barrel 606 may hold two or more, three or more, four or more, or even five or more lenses in a fixed arrangement along an optical axis as shown below in FIG. 7 as element 722. The lens barrel 606 may be fixedly connected to the lens mount 604. The lens barrel 606 may movably connect to the lens mount 604. The lens barrel 606 may move along the optical axis relative to the lens mount 604. The lens barrel 606 may be removed from the lens mount 604 after the lens barrel 606 is installed within the lens mount 604. The lens barrel 606 may be located axially behind a lens sub-barrel 608 relative to the image sensor 602 such that the lens barrel 606 is located between the lens sub-barrel 608 and the image sensor 602.

The lens sub-barrel 608 may be connected to the lens barrel 606, the lens mount 604, or both. The lens sub-barrel 608 may extend around the lens mount 604, the lens barrel 606, or both. The lens sub-barrel 608 may be movable relative to the lens mount 604, the lens barrel 606, or both. The lens sub-barrel 608 may be adjustable along the optical axis of the ISLA 600. The lens sub-barrel 608 may include one or more sub-barrel lenses, two or more sub-barrel lenses, or even three or more sub-barrel lenses 610.

The sub-barrel lenses 610 may function to direct light into the lens sub-barrel 608, into the lens barrel 606, into the lens mount 604, towards the image sensor 602, or a combination thereof. The sub-barrel lenses 610 may direct light onto the image sensor 602. The sub-barrel lenses 610 may include a forward most lens shown as 720′ of FIG. 7. The forward most lens 720 of the sub-barrel lenses 610 may be movable relative to a forward most lens of the lens barrel 606 by moving the lens sub-barrel 608. The relationship of the lenses in the lens barrel 606 and the lens sub-barrel 608 is that such lenses are connectably movable relative to one another by the fasteners depicted below in FIG. 7.

FIG. 7 is a cross-sectional view of the ISLA 600 of FIG. 6 along lines VII-VII, referred to as ISLA 700. The ISLA 700 functions to direct light into an image capture device to capture images. The ISLA 700 includes a rearward end and a forward end. The rearward end of the ISLA 700 includes an image sensor 702.

The image sensor 702 functions to capture images that are directed onto the image sensor 702. The image sensor 702 may be in communication with a lens mount 704.

The lens mount 704 may be fixedly connected to the image sensor 702 such that the lens mount 704 fixes the image sensor within the ISLA 700. The lens mount 704 may form a connection within an image capture apparatus such as the image capture apparatuses 100, 200, 300, 400, or 500. The lens mount 704 may directly connect to a housing of an image capture apparatus. The lens mount 704 may be free of a direct connection with a housing of an image capture apparatus. The lens mount 704 may extend cantilevered away from a wall or a housing of an image capture apparatus so that the image sensor 702 is only connected to the lens mount 704. The image sensor 702 may be located at a rear end of the lens mount 704. A forward end of the lens mount 704 may include lens mount fasteners 706. Thus, a rear end of the lens mount 704 is connected to the image sensor 702 and a front end of the lens mount 704 includes the lens mount fasteners 706.

The lens mount fasteners 706 may connect the lens mount 704 within an image capture apparatus as discussed herein. The lens mount fastener 706 may connect the lens mount 704 to one or more barrels, lenses, or both within the ISLA 700. The lens mount fasteners 706 may be a mechanical connection, an adhesive connection, or both. The lens mount fasteners 706 may form a removable connection. The lens mount fasteners 706 may form a temporarily movable connection. The lens mount fasteners 706 may be glue, a weld, threads, one or more detents, teeth, a bayonet connection, or a combination thereof. The lens mount fasteners 706 may create a rotational to axial connection along an optical axis 722 of the ISLA 700. For example, as another device rotates about the lens mount 704, the other device may move along a longitudinal axis a desired distance. The lens mount 704 may be connected to a lens barrel 708.

The lens barrel 708 functions to house lenses within the ISLA 700. The lens barrel 708 may be fixedly connected to one or more lenses or a plurality of lenses. The lens barrel 708 may extend into the lens mount 704 so that the lens barrel 708 is movable relative to the lens mount 704. Once the lens barrel 708 is moved into a desired position, the lens barrel 708 may be fixedly connected to the lens mount 704. The lens mount 704 and the lens barrel 708 may be connected via lens barrel fasteners 710.

The lens barrel fasteners 710 may be complementary to the lens mount fasteners 706. The lens barrel fasteners 710 may be substantially identical to the lens mount fasteners 706. The lens barrel fasteners 710 may be movable into communication with the lens mount fasteners 706 and then move along the lens mount 704. The lens barrel fasteners 710 may be made of a same material as the lens mount fasteners 706. The lens barrel fasteners 710, the lens mount fasteners 706, or both may be made of or include a polymer, plastic, metal, aluminum, steel, titanium, magnesium, iron, or a combination thereof. The lens barrel fasteners 710 may be threads that connect to threads of the lens mount fasteners 706. When the lens barrel fasteners 710 are in communication with the lens mount fasteners 706, the lens barrel 708 is axially movable relative to the lens mount 704 along the optical axis 722. Once the lens mount 704 and the lens barrel 708 are moved into a final position, the lens mount fasteners 706 may be fixed relative to the lens barrel fasteners 710. For example, if the lens mount fasteners 706 and the lens barrel fasteners 710 are threads, then a connecting agent may be applied (e.g., a thread locker, adhesive, glue, weld, or a combination thereof) to form a fixed connection therebetween. A connecting agent may be applied to fixedly connect the lens mount fasteners 706 and the lens barrel fasteners 710 together or to fixedly connect other fasteners taught herein. The lens barrel fasteners 710 may retain the lens barrel 708 and corresponding ones of lens barrel lenses 712 in a fixed position.

The lens barrel lenses 712 function to direct light towards the image sensor 702. The lens barrel lenses 712 are a plurality of lenses of varying size and shape. The lens barrel lenses 712 may include a forward most lens 712′. The lens barrel lenses 712 may extend along a length of the lens barrel 708. The forward most lens 712′ may be located adjacent to lens barrel outer fasteners 714.

The lens barrel outer fasteners 714 may form or be located on an outer portion of the lens barrel 708, extend around the forward most lens 712′, or both. The lens barrel outer fasteners 714 may be the same type of fasteners as the lens mount fasteners 706, the lens barrel fasteners 710, or both. The lens barrel outer fasteners 714 may be made of or include a polymer, plastic, metal, aluminum, steel, titanium, magnesium, iron, or a combination thereof. The lens barrel outer fasteners 714 may be glue, a weld, threads, one or more detents, teeth, a bayonet connection, or a combination thereof. The lens barrel outer fasteners 714 may connect the lens barrel 708 to a lens sub-barrel 716.

The lens sub-barrel 716 functions to connect one or more lenses of the lens sub-barrel 716 located axially forward of the lens barrel 708 along the optical axis 722. The lens sub-barrel 716 is removable, movable, or both. The lens sub-barrel 716 may be a second lens barrel that connects to the lens barrel 708. The lens sub-barrel 716 may connect to the lens barrel 708 via sub-barrel fasteners 718.

The sub-barrel fasteners 718 may be complimentary to the lens barrel outer fasteners 714. The sub-barrel fasteners 718 may be any of the materials or fastener types discussed herein regarding the lens barrel outer fasteners 714, the lens barrel fasteners 710, the lens mount fasteners 706, or a combination thereof. The sub-barrel fasteners 718 may be threads or detents. The sub-barrel fasteners 718 may be located on an interior of the lens sub-barrel 716. The sub-barrel fasteners 718 may extend around the lens barrel outer fasteners 714 so that a fixed connection is formed there between. The sub-barrel fasteners 718 may fix one or more sub-barrel lenses 720 in position relative to the forward most lens 712′.

The sub-barrel lenses 720 are located a distance from the forward most lens 712′ based on a position of the lens sub-barrel 716 with respect to the lens barrel 708. The sub-barrel lenses 720 may be adjusted in position by moving the lens sub-barrel 716 relative to the lens barrel 708. The sub-barrel lenses 720 may be one or more lenses, two or more lenses, or three or more lenses. The sub-barrel lenses 720 may include only a single lens 720′. The sub-barrel lenses 720 may include one or more additional lenses axially behind the single lens 720′ along the optical axis 722. The single lens 720′ may distribute light into the lens barrel 708 to be directed by the lens barrel lenses 712. The single lens 720′, the sub-barrel lenses 720, or both may direct light through the lens barrel lenses 712 towards the image sensor 702. Changing a distance between the single lens 720′ and the forward most lens 712′ may change how the light extends through the lens barrel 708 onto the image sensor 702. Moving the single lens 720′ of the lens sub-barrel 716 relative to the lens barrel 708 along the optical axis 722 adjusts how light extends through the ISLA 700.

The lens sub-barrel 716 is movable along the optical axis 722 to change how the light passes to the image sensor 702. The lens sub-barrel 716 may be movable a distance of about 1 micron or more, about 2 microns or more, or about 3 microns or more. The lens sub-barrel 716 may be movable about 100 microns or less, about 75 microns or less, about 50 microns or less, or about 25 microns or less. Once the lens sub-barrel 716 is adjusted along the optical axis 722, the lens sub-barrel 716 may be locked in place. The lens sub-barrel 716 may focus light, and once a pre-determined focus is established the pre-determined focus may be fixed along the optical axis 722.

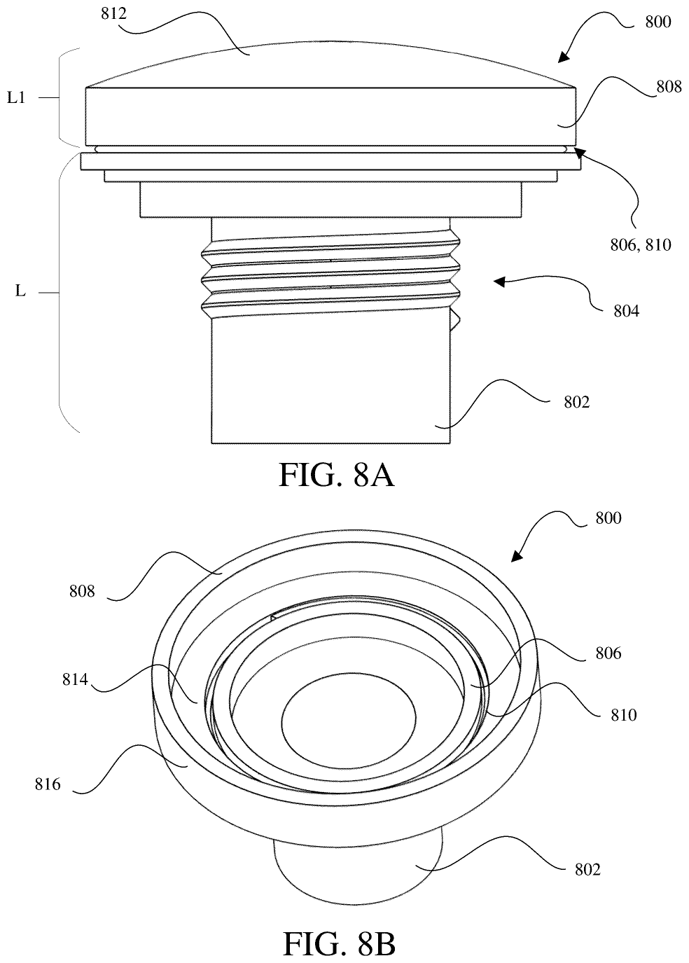

FIG. 8A illustrates a partial image sensor and lens assembly (ISLA) 800. A lens barrel 802 of the ISLA 800 is shown removed from the lens mount 704 as shown in FIG. 7. The lens barrel 802 extends a length (L) with lenses (not shown) located along the length (L). The lens barrel 802 retains lenses and movably aligns lenses relative to an image sensor 702 of FIG. 7. The lens barrel 802 is movably connectable by lens barrel fasteners 804.

The lens barrel fasteners 804 function to move the lens barrel 802 relative to the lens mount (e.g., 700). The lens barrel fasteners 804 may move in a rotational to axial direction. The lens barrel fasteners 804 may form a connection without rotational movement. The lens barrel fasteners 804 may be a plurality of steps that the lens barrel 802 is movable along. The lens barrel fasteners 804 may allow the ISLA 800 to have a first amount of adjustment or a first region of adjustment. The lens barrel 802 may include lens barrel outer fasteners 806.

The lens barrel outer fasteners 806 may connect a lens sub-barrel 808 to the lens barrel 802. The lens barrel outer fasteners 806 may form a connection in a same manner as the lens barrel fasteners 804 discussed herein. The lens barrel outer fasteners 806 may allow the ISLA 800 to have a second amount of adjustment or a second region of adjustment. The lens barrel outer fasteners 806 may movably connect the lens sub-barrel 808 to the lens barrel 802 by sub-barrel fasteners 810.

The lens sub-barrel 808 may include a length (L1) that houses one or more sub-barrel lenses 812. The sub-barrel lenses 812 are movable by the lens sub-barrel 808 being moved relative to the lens barrel 802. The sub-barrel lenses 812 is movable by the sub-barrel fasteners 810 moving the sub-barrel lenses 812 relative to the lens barrel outer fasteners 806.

FIG. 8B is an isometric view of the ISLA 800 of FIG. 8A with the sub-barrel lenses 812 removed so that the lens barrel outer fastener 806 and sub-barrel fastener 810 are exposed. The lens barrel 802 and lens barrel outer fastener 806 extends into the lens sub-barrel 808. The sub-barrel fasteners 810 movably connect to the lens barrel outer fasteners 806. Thus, by moving the lens sub-barrel 808 about the lens barrel 802 the ISLA 800 the ISLA may be focused.

The lens sub-barrel 808 includes a shoulder 814 and wall 816 to retain the sub-barrel lenses 812 therein. The shoulder 814 may form a lower surface of the lens sub-barrel 808 that the sub-barrel lenses 812 rests upon. The shoulder 814 may create a consistent connection location of the sub-barrel lenses 812 with the lens sub-barrel 808. The wall 816 may enclose all or a portion of the sub-barrel lenses 812. The wall 816 may be an annular wall. The wall 816 may have a height that substantially equal to or less than a height of the sub-barrel lenses 812. The wall 816 may align the sub-barrel lenses 812 within the lens sub-barrel 808. The shoulder 814 may align the sub-barrel lenses 812 along an optical axis and the wall 816 may align the sub-barrel lenses 812 about the optical axis.

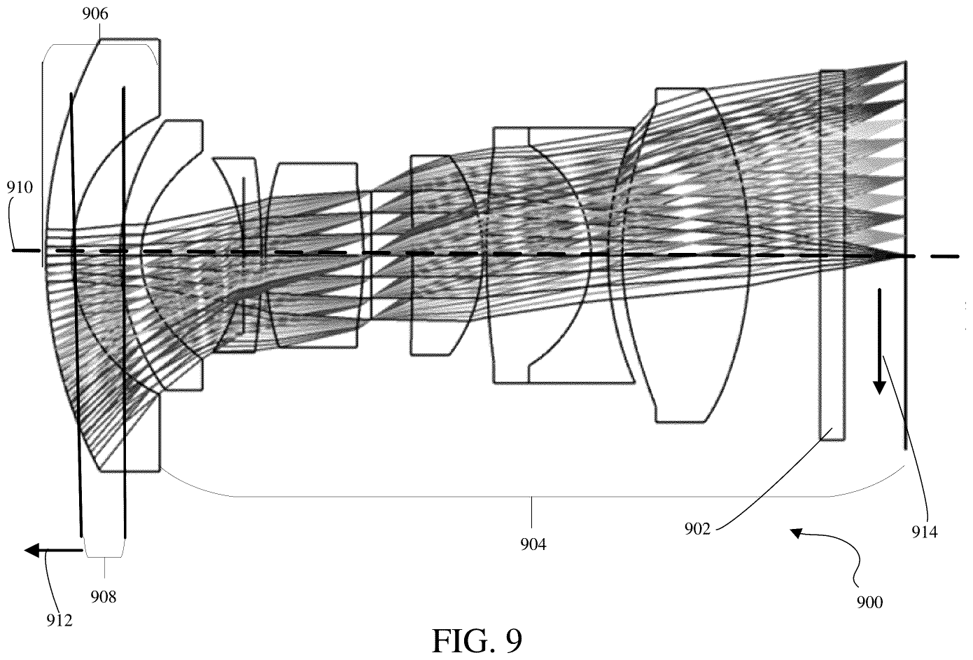

FIG. 9 illustrates lenses of an image sensor and lens assembly (ISLA) 900 with light passing therethrough. The light is directed through lenses of the ISLA 900 onto the image sensor 902. As shown, the light is not contacting a central region of the image sensor 902. A multitude of lens barrel lenses 904 are axially located directly forward of the image sensor 902 such that the light extends through the multitude of lens barrel lenses 904 before contacting the image sensor 902. The multitude of lens barrel lenses 904 are located between sub-barrel lenses 906 and the image sensor 902. As shown, light enters the sub-barrel lenses 906 and then extends through the lens barrel lenses 904 until the light contacts the image sensor 902. The first lens of the sub-barrel lenses 906 is spaced apart from a forwardmost lens of the multitude of lens barrel lenses 904 by a gap 908.

The gap 908 is a distance between the forwardmost lens of the multitude of the lens barrel lenses 904 and the forward sub-barrel lens 904. The gap 908 is changeable along an optical axis 910. Thus, as a distance between the lens barrel lenses 904 and the sub-barrel lenses 906 changes a direction of the light through the ISLA 900. As the distance is changed the light may be moved along the image sensor 902 relative to the optical axis so that the light is aligned substantially along the optical axis 910 (e.g., colinearly) onto the image sensor 902. For example, moving the sub-barrel lenses 906 in a direction axially forward or backward may move the light in a lateral direction 914 relative to the optical axis 910. Changing the gap 908 distance may move the light laterally relative to the optical axis 910 so that the light may focused onto the image sensor 902. As show, the light enters the sub-barrel lenses 906 offset to one side of the optical axis 910. The light is directed along the optical axis 910 through the lens barrel lenses 904 so that the light hits the image sensor 902 in a location offset relative to the optical axis 910. As shown, by moving the sub-barrel lenses 906 in a forward direction 912 to increase the gap 908 the light is moved in the lateral direction 914 towards a center of the image sensor 902 along the optical axis 910.

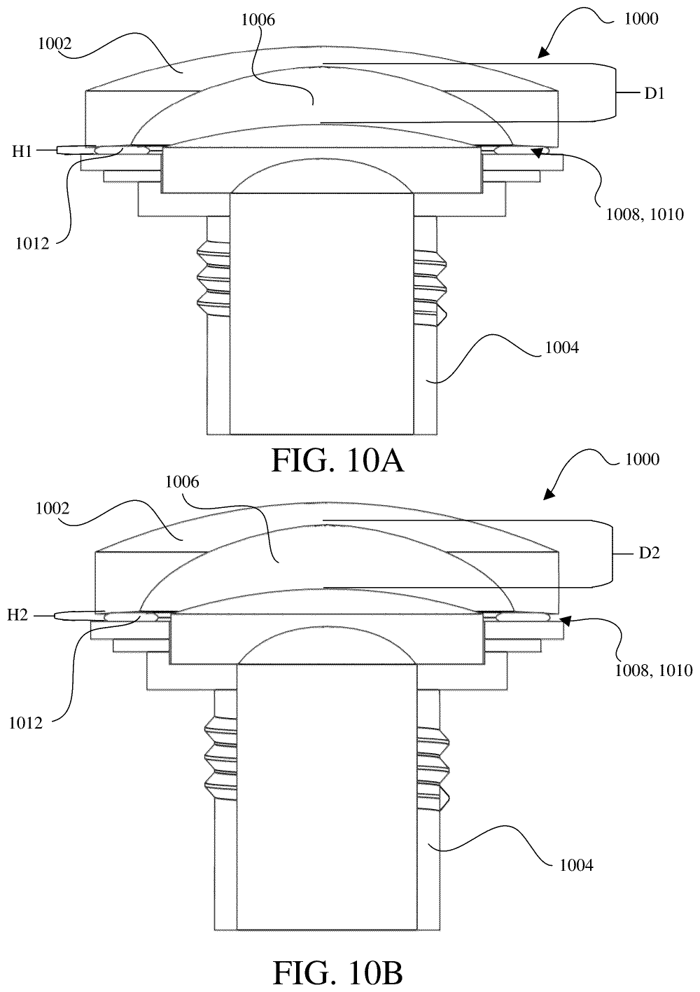

FIG. 10A illustrates a cross-sectional view of an image sensor and lens assembly (ISLA) 1000. The ISLA 1000 includes a lens sub-barrel 1002 that is connectable to a lens barrel 1004. The lens sub-barrel 1002 and the lens barrel 1004 are spaced apart a distance (D1) forming a gap 1006 therebetween. The gap 1006 is adjustable so that the lens sub-barrel 1002 is movable towards and away from the lens barrel 1004. The lens sub-barrel 1002 and the lens barrel 1004 are connected together by lens barrel outer fasteners 1008 of the lens barrel 1004 receiving sub-barrel fasteners 1010 of the lens sub-barrel 1002. The lens sub-barrel 1002 is movable relative to the lens barrel 1004 while a connection is maintained therebetween to allow adjustment of the ISLA 1000. Thus, adjusting the lens sub-barrel 1002 relative to the lens barrel 1004 changes the gap 1006 and a distance 1012 between the lens sub-barrel 1002 and the lens barrel 1004. As shown the gap 1006 has a distance (D1) and the space 1012 has a height (H1).

FIG. 10B illustrates the lens sub-barrel 1002 moved away from the lens barrel 1004. The gap 1006 size is increased from D1 to D2 and the height is increased from H1 to H2 so that light extending therethrough is focused, the direction of the light through the ISLA 1000 is changed, or both. Thus, light extending through the ISLA 800 as arranged in FIG. 10A will have a different focus than the light extending through the ISLA 800 as arranged in FIG. 10B. Once a desired focus (or alignment) is achieved then the lens sub-barrel 1002 may be locked relative to the lens barrel 1004.

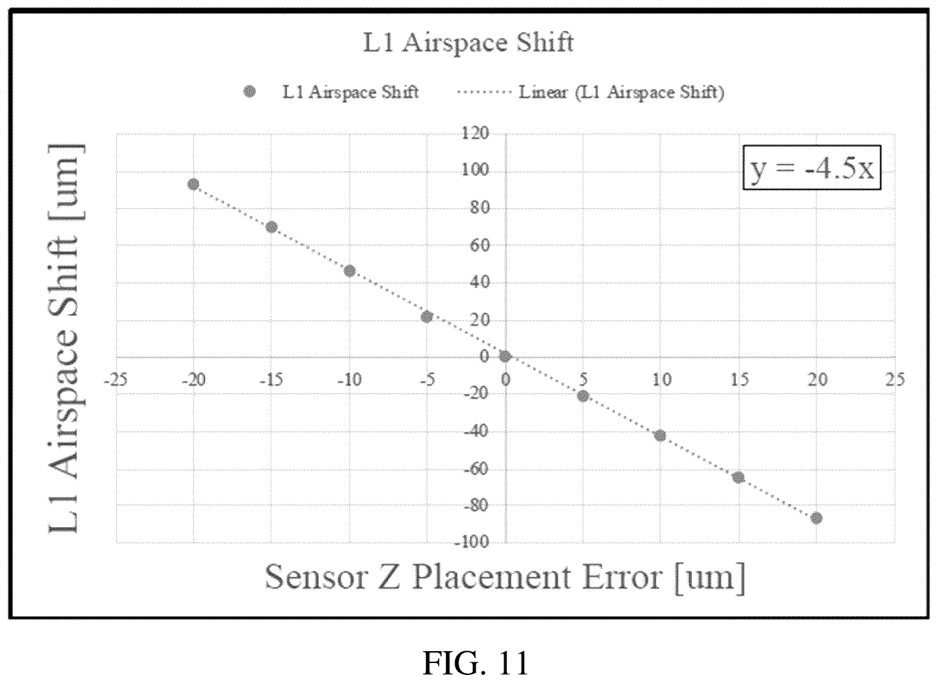

FIG. 11 illustrates a graphical representation of moving the lens sub-barrel 608, 716, 808, 1002 relative to the lens barrel 606, 708, 802, 1004 so that a gap 908, 1006 there between is adjusted. As shown, the lens L1 is movable forward from zero microns to 20 microns or backwards to −20 microns. The lens L1 may be movable a distance of about ±30, about ±25, or about ±22.5. Movement of the lens L1 in a first direction may move the light a predetermined distance in a second direction. Movement of the lens L1 a first distance may cause the light to move a second distance. The first distance of lens L1 and the second distance of the light may have a ratio of movement. The ratio of movement of the lens L1 to the movement of the light may be about 1:1 or more, 2:1 or more, 5:1 or more, 7:1 or more, or even about 10:1 or more. The ratio may be about 50:1 or less, 25:1 or less, 15:1 or less, or about 12:1 or less. Thus, for example, if a ratio is 10:1 then if the lens moves 10 microns and the light moves 1 micron. The change in movement may be a sensitivity of movement. The lens L1 may have sensitivity of about 1× or more, 2× or more, 3× or more, 4× or more, or about 4.5× or more. The lens L1 may have a sensitivity of about 10× or less, about 8× or less, about 6× or less. For example, if the sensitivity is 4.5× then a movement of the lens L1 4.5 microns will result in the light moving a distance of 1 micron.

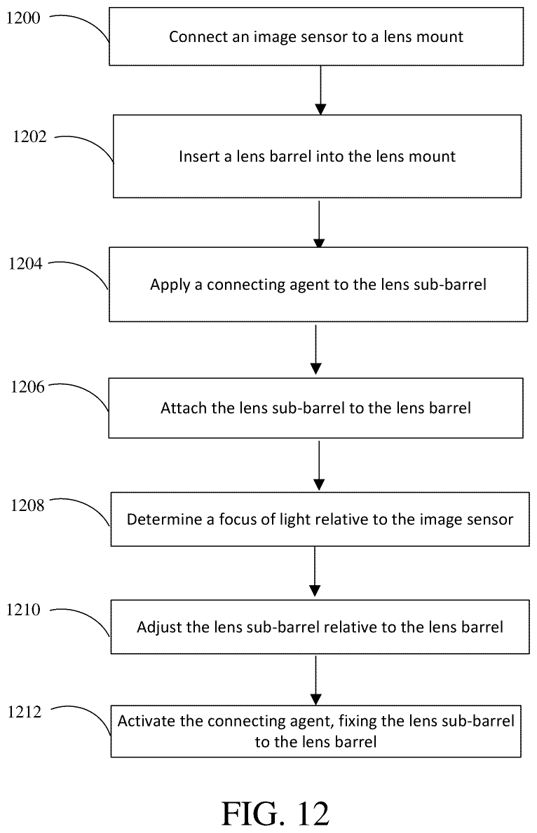

FIG. 12 illustrates a block diagram of steps to construct and focus an ISLA 600, 700, 800, 900, 1000. Lenses of the ISLA may be connected within barrels of the ISLA. Assembly of the ISLA includes connecting 1200 an image sensor to a lens mount. The image sensor may be connected 1200 to an end of the lens mount. The image sensor may be connected 1200 to the lens mount by being inserted into the lens mount. The image sensor may be connected 1200 to a rear end of the lens mount and a front end of the lens mount may include an opening.

A lens barrel may be inserted 1202 into the opening of the lens mount. The lens barrel may be inserted 1202 into the lens mount with fasteners (e.g., lens barrel fasteners and lens mount fasteners). The lens barrel may be removably connected to the lens mount. The lens barrel may be permanently connected to the lens mount. The lens barrel may be inserted 1202 and then rotated or moved into a final position. Once the lens barrel and lens mount are connected a lens sub-barrel may be prepared for connection to the lens mount.

The lens sub-barrel may be prepared before the lens sub-barrel is connected to lens mount, the lens barrel, or both. The lens sub-barrel may have a connecting agent applied 1204 before, during, or after the lens sub-barrel is attached to the lens barrel, the lens mount, or both. The connecting agent may include a cure mechanism, a cure delay mechanism, or the like. The cure mechanism may be moisture, ultraviolet light, heat, temperature, chemical activation, or a combination thereof. The connecting agent may not begin to cure until the connecting agent is activated. The connecting agent may cure to a first level upon being contacted with a cure mechanism and then later cure to a second level. The connecting agent may be applied 1204 to a lens barrel outer fastener, a sub-barrel fastener, or both. Once the connecting agent is applied 1204, the lens sub-barrel and the lens barrel may be attached 1206 together.

The lens sub-barrel may be attached 1206 to an outside of the lens barrel. The lens sub-barrel may be attached 1206 to an outside of the lens mount. The lens sub-barrel may be attached 1206 to an inside of the lens mount, the lens barrel, or both. The lens sub-barrel may be attached 1206 via one or more fasteners. The lens-sub barrel may be attached 1206 to the lens barrel, the lens mount, or both. Once the lens-sub barrel is attached 1206 the lens barrel, the lens mount, or both may be tested, checked, determined 1208, or a combination thereof regarding a focus or alignment of a resultant ISLA.

The focus or alignment of the ISLA may be determined 1208 by directing light through the lenses in the lens sub-barrel and the lenses in the lens barrel and determining 1208 where the light contacts the image sensor. The focus may be determined 1208 by sweeping the ISLA in one or more axes, two or more axes, three or more axes, or four or more axes. For example, the ISLA may be pivoted and light entering the ISLA as the ISLA pivots may be monitored. The ISLA may be rotated so that light may enter the lenses at one or more angles to determine 1208 how the light contacts the light sensor. The focus may be determined 1208 by measuring a distance the light contacts the image sensor relative to an optical axis of the ISLA. For example, the optical axis may contact the image sensor at a known location and a concentration of light relative to the optical axis may be measured. Conversely, the amount of the image sensor that does not receive and light may be determined 1208 to determine alignment of the ISLA. A location or area the light contacts the image sensor may be determined 1208. For example, if the image sensor is a square and the light only contacts 75% of the square the focus may be determined 1208 to be out of focus such that adjustment may be needed. During the step of determining 1208, a distance the light is centered from the optical axis may be measured (e.g., light out of alignment). The distance may be about one micron or more, about two microns or more, or about three microns or more. The distance may be about ten microns or less, about eight microns or less, about six microns or less, or about four microns or less. A length the lens sub-barrel may be moved is dependent upon the sensitivity discussed herein. A determination of the distance out of alignment may determine a length of axial movement the lens sub-barren needs to move to focus the light within the ISLA. An airgap between the lens barrel lens and the sub-barrel lens changes as the lens sub-barrel moves the length. During a step of determining 1208 an amount of re-focusing may be calculated such that an amount of adjustment 1210 of the lens sub-barrel may be calculated, ascertained, looked-up, or a combination thereof.

The lens sub-barrel may be adjusted 1210 relative to the image sensor, the lens barrel, the lens mount, or a combination thereof. The lens sub-barrel may be adjusted 1210 along the optical axis of the ISLA. The lens sub-barrel may be rotated about the optical axis so that the lens sub barrel moves axially along the optical axis. The lens sub-barrel may move axially forward or axially rearward. Once the lens-sub barrel is adjusted 1210, focus of the light relative to the image sensor may be determined again (e.g., re-checked). A step of re-checking may not be performed and the ISLA may be completed.

The ISLA may be completed by activating 1212 the connecting agent. The connecting agent may be activated 1212 to get a partial cure (e.g., the connecting agent may become tacky). When the connecting agent is activated 1212 the lens sub barrel may be fixedly connected to the lens barrel, the lens mount, or both. The connecting agent may be activated 1212 between an image sensor and lens mount, a lens mount and a lens barrel, a lens barrel and a sub-lens barrel, or a combination thereof. Once the connecting agent is activated 1212 the focus of light within the ISLA may be fixed.

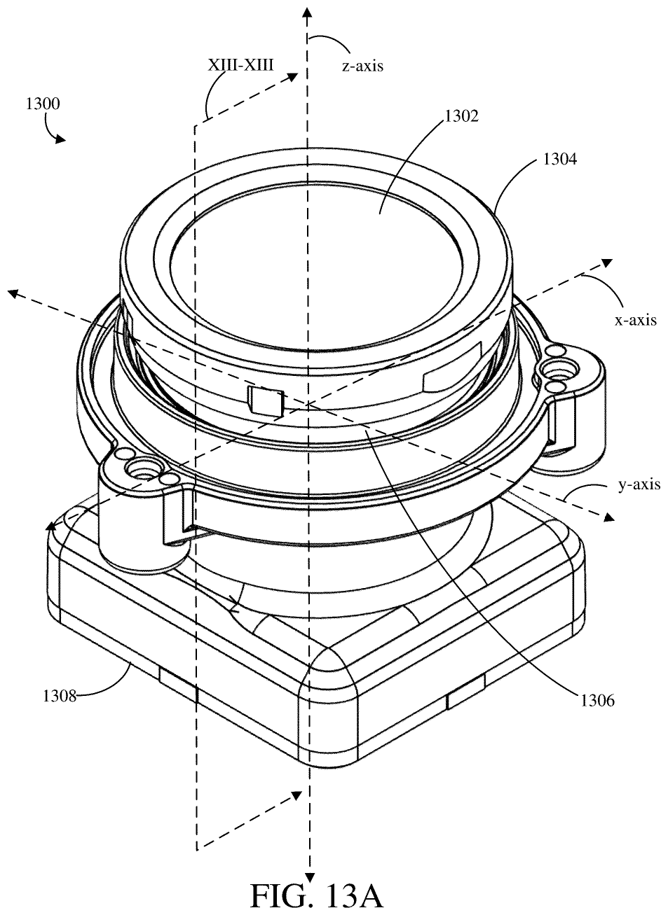

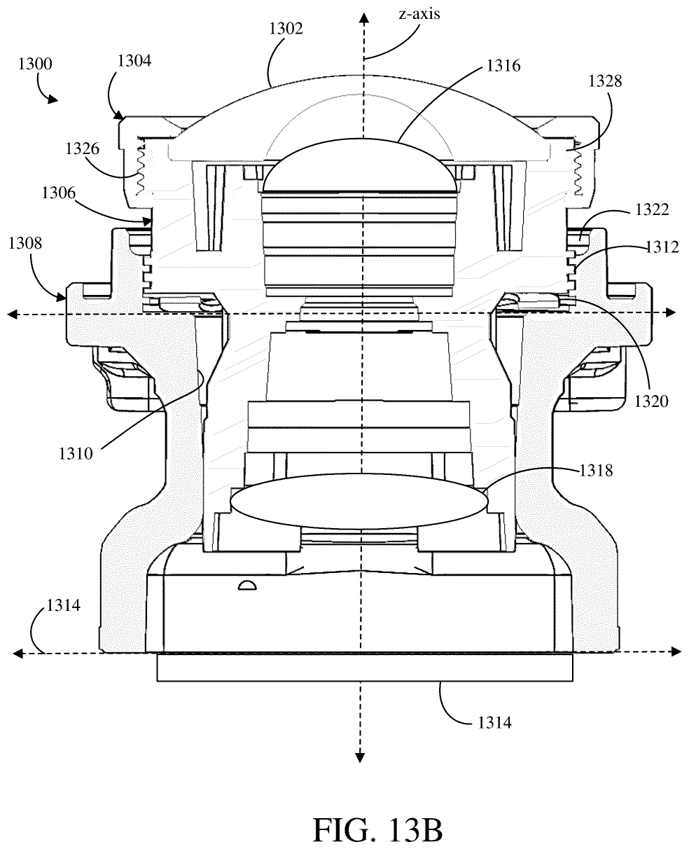

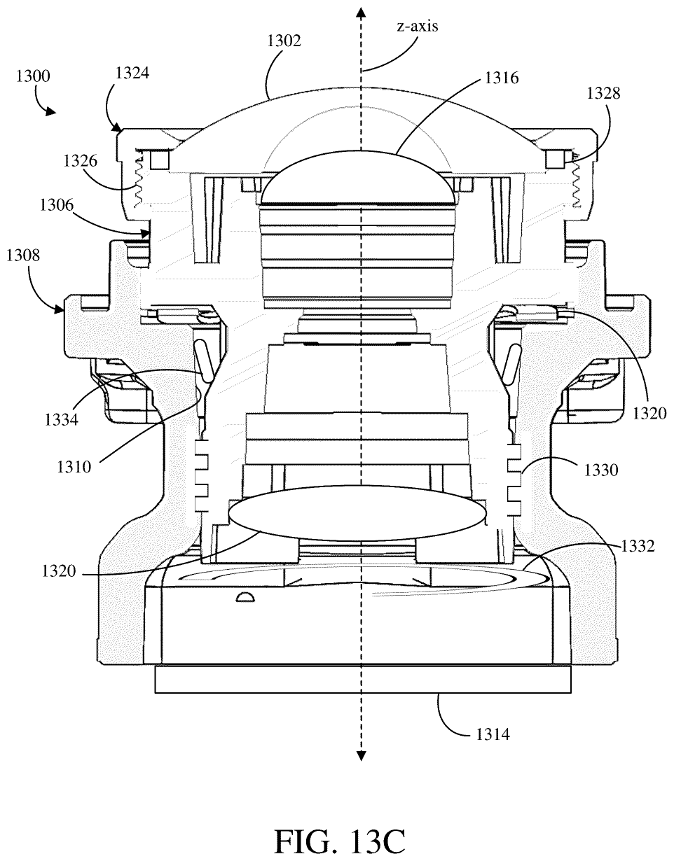

FIG. 13A is a perspective view of a lens assembly (ISLA) 1300, which may be useable with the image capture apparatuses 100, 200, 300, 400 of FIGS. 1A-4. The ISLA 1300 includes an external lens 1302 that may be curved, a lens mount 1304 to secure the external lens 1302 over a lens barrel 1306 (which may be referred to as a barrel housing), and a mount housing 1308 configured to receive the lens barrel 1306 through a barrel receptacle (not shown, see, a barrel receptacle 1310 of FIGS. 13B-13C). To achieve desirable optical alignment, the lens barrel 1306 is aligned along one or more of an x-axis, a y-axis, and/or a z-axis. In combination, the external lens 1302, the lens mount 1304, and the lens barrel 1306 (along with components included on or within the lens barrel 1306, see FIGS. 13B-13C) may be referred to as a lens barrel assembly.

Along line XIII-XIII, FIGS. 13B-13C are cross-sectional views of the ISLA 1300 with different arrangements to achieve optical alignment along the z-axis, which may be referred to as an optical axis.

FIG. 13B shows a mounting interface 1312 that is configured to move the lens barrel 1306 within the barrel receptacle 1310 so that the lens barrel 1306 moves along the z-axis. Movement along the z-axis adjusts the position of the lens barrel 1306 relative to the image sensor 1314 such that the external lens 1302, a internal lens 1316, and/or a focal lens 1318 are adjusted to an optical distance from the image sensor 1314. Moving the lens barrel along z-axis may be referred to as a lens barrel adjustment.

The mounting interface 1312 is configured to both connect the lens barrel 1306 and the barrel receptacle 1310 and to allow movement of the lens barrel 1306 within the barrel receptacle 1310 along the z-axis. The mounting interface 1312 may include any type of mounting interface position on lateral walls of the lens barrel 1306 and/or barrel receptacle 1310. For example, the mounting interface 132 may include threads on either or both of the lens barrel 1306 and/or barrel receptacle 1310 that are configured to allow movement along the z-axis by rotating the lens barrel 1306 relative to the barrel receptacle 1310.

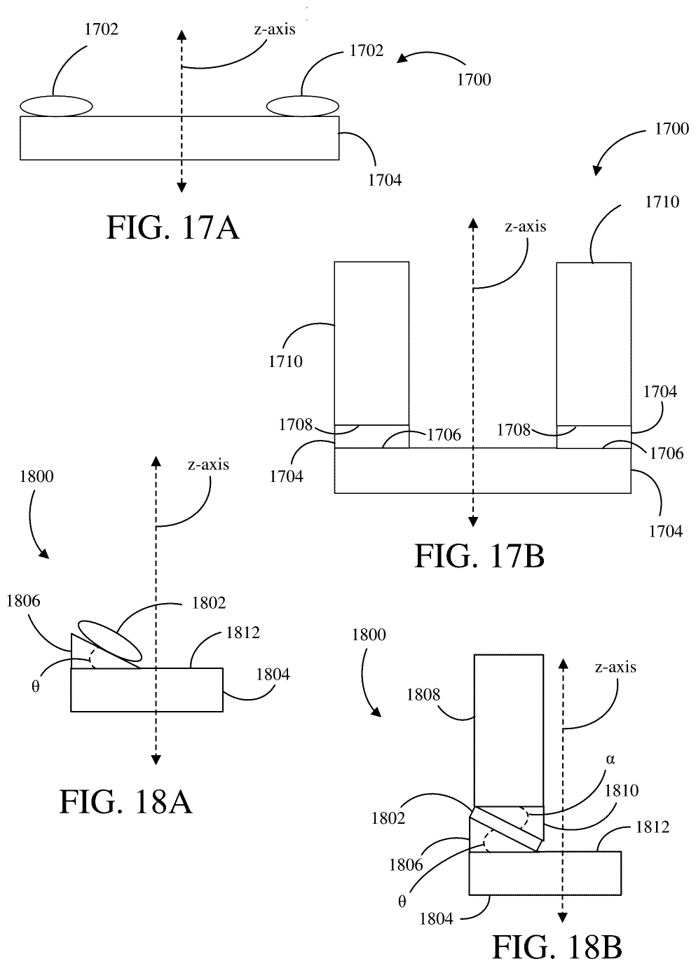

Any connection mechanism may be used in the mounting interface 1312 to allow the rotation of the lens barrel 1306 relative to the barrel receptacle 1310 such that movement occurs along the z-axis. In some examples, the profile of the mounting interface 1312 relative to the z-axis may have an angle and be configured such that movement occurs along the z-axis and is eliminated or minimized along the x-axis and/or y-axis. For example, the mounting interface 1312 may have a profile of square threads, v-threads, trapezoidal threads, buttress threads, acme threads, pipe threads, knuckle threads, winged threads, self-tapping threads, or any combination thereof. In some examples, the mounting interface 1312 may include one or more adhesives (see, e.g., adhesives 1802, 1902, 2002, 2102 of FIGS. 17A-21B) that can be optionally cured within the mounting interface 1312 after optical alignment is achieved.

When assembling the lens barrel 1306 and the mount housing 1308, the image sensor 1314 may be tested, such as by detecting light or capturing an image, and determine the focus and field or depth of view of the current arrangement of the lens barrel 1306 (and, subsequently, the external lens 1302, the internal lens 1316, and the focal lens 1318) relative to the image sensor 1314. If an anomaly or an issue is detected through light detection or image capturing, lens barrel 1306 may be rotated relative to the mount housing 1308 a desirable number of microns either up or down the z-axis such that desirable images are captured or light is detected by the image sensor 1314 through the external lens 1302, the internal lens 1316, and the focal lens 1318. The optical adjustments and image sensor testing may be repeated until desirable optical alignment is achieved.

During optical alignment and/or assembly of the lens barrel 1306 and/or the mount housing 1308, a flange biasing member 1320 is used to apply forces against the mount housing 1308, the lens barrel 1306, and/or the mounting interface 1312 such that optical alignment is achieved and movement at the mounting interface 1312 is minimized. For example, one or more optical adjustments may be performed at the mounting interface 1312, and the flange biasing member 1320 may be configured to push against threads of the mounting interface 1312 such that vibrations, wiggling, undesired rotation post optical alignment, or an other movement at the mounting interface 1312 that may otherwise impact optical alignment with respect to any of the x, y, and/or z-axis. For example, if an image capture apparatus is dropped or bumped before, during, or after operation, the flange biasing member 1320 may be configured to avoid movement of the lens barrel 1306 relative to the barrel receptacle 1310.

As the flange biasing member 1320 is effective to avoid undesirable movement may be included within a combination of the lens barrel 1306 and/or barrel receptacle 1310. For example, the combination of the lens barrel 1306 and/or barrel receptacle 1310 may include one or more, two or more, three or more, four or more, five or more, or a plurality of the flange biasing members 1320 either together or separately in locations adjacent to or spaced from the mounting interface 1312 (see e.g., FIG. 13C). For example, the flange biasing member 1320 is positioned between flanges of the lens barrel 1306 and/or barrel receptacle 1310 such that the flange biasing member 1320 is adjacent to the mounting interface 1312. In other examples, the flange biasing member 1320 may be positioned at a location on the lens barrel 1306 and/or barrel receptacle 1310 between the focal lens 1318 and the image sensor 1314 such that forces are applied on the mounting interface 1312 at location that is spaced from the mounting interface 1312 by intervening components.

After optical alignment is achieved in FIG. 13C, the mounting interface 1312 may be fixed (i.e., so no rotation or movement along any of the x, y, z axes may occur) by curing an adhesive (not shown, see, e.g., adhesives 1802, 1902, 2002, 2102 of FIGS. 17A-21B) at a well 1322 positioned on an external surface of the lens barrel 1306. The well 1322 is configured to receive, hold, and avoid leaking of the adhesive (not shown) or a sealant (not shown) before and after curing such that the lens barrel 1306 does not move out of optical alignment during use of the image capture apparatus and debris does not enter the space between the lens barrel 1306 and the barrel receptacle 1310. Separately from the well 1322, an adhesive (not shown) may be applied within the mounting interface 1312 and optionally cured after optical alignment is achieved. In some examples, a single or combination of adhesives may be advantageous to maintain optical alignment and to avoid any debris from entering the spaces between the lens barrel 1306 and the barrel receptacle 1310.

On the other hand, FIG. 13C shows the lens barrel 1306 and barrel receptacle 1310 connected in a different arrangement. An internal mounting interface 1330 is in a different arrangement and/or location than mounting interface 1312 but has a similar function, arrangement, and structure as the mounting interface 1312. The internal mounting interface 1330 is positioned between internal lateral walls of the lens barrel 1306 and the barrel receptacle 1310 such that the internal mounting interface 1330 is protected from external factors, such as debris, water, and the like and adjacent to the focal lens 1318. In other examples, the internal mounting interface 1330 may be positioned between any of the walls of the lens barrel 1306 and the barrel receptacle 1310 such that rotation is possible and movement along the z-axis can occur.

Additionally, the internal mounting interface 1330 of FIG. 13C is positioned between the flange biasing member 1320 and a barrel biasing member 1332, which apply forces along the z-axis and are sized and positioned to avoid interference with the image sensor 1314, so that a combination of the flange and barrel biasing members 1332 can be used to hold the lens barrel 1306 in optical alignment. The barrel biasing member 1332 is positioned between the image sensor 1314 and the lens barrel 1306 such that forces can be applied between the lens barrel 1306 and the barrel receptacle 1310 without obstructing the external lens 1302, the internal lens 1316, the focal lens 1318, and/or the image sensor 1314. Additionally, the internal mounting interface 1330 is maintained in optical alignment relative to the x and y axes by a radial biasing member 1332 that is configured to avoid lateral shifts that may impact the optical alignment. In some examples, the mounting interface 1312 at the flange of the lens barrel 1306 and the barrel receptacle 1310 and internal mounting interface 1330 may be used in combination with none, some, or all of the flange, sensor, and radial biasing members 1320, 1332, 1334

The flange, sensor, and radial biasing members 1320, 1330, 1332 may have any arrangement sufficient to apply forces along one or more of the x, y, and/or z-axes when the lens barrel 1306 and barrel receptacle 1310 are connected. The flange, sensor, and radial biasing members 1320, 1332, 1334 may be composed of any material sufficient to apply forces along one or more of the x, y, and/or z-axes when the lens barrel 1306 and barrel receptacle 1310 are connected. The flange, sensor, and radial biasing members 1320, 1332, 1334 may be configured as an elastic members (e.g., gaskets or o-rings), spring, magnets, actuators, washers, or any combination thereof. The flange, sensor, and radial biasing members 1320, 1332, 1334 may be positioned at or connected with any location between, within, or on the lens barrel 1306, the barrel receptacle 1310, the mount housing 1308, and/or any other location sufficient to apply forces on the lens barrel 1306 along the x, y, and z-axes.

Before or after optical alignment is achieved between the lens barrel 1306 and the barrel receptacle 1310 in either or both of FIGS. 13A-13B, the external lens 1302, which is connected to the lens barrel 1306 through the lens mount 1304 that includes a lens interface 1326, may be adjusted along the z-axis such that optical alignment is achieved or maintained. The lens interface 1326 may achieve movement along the z-axis through a mechanism similar to the mounting interface 1312. A lens adhesive 1328 (which may be similar to other adhesives like the adhesives 1802, 1902, 2002, 2102 of FIGS. 17A-21B) may be applied to the lens interface 1326 to connect the external lens 1302 and the lens mount 1304. In some examples, the lens interface 1326 is not included and the external lens 1302 is secured by the lens adhesive 1328 only. In some examples, another external lens (not shown) that is optionally curved or flat may be applied over the external lens 1302. Before or after optical alignment is achieved, the other external lens (not shown) may optionally be connected with or overlayed with the external lens 1302, the lens barrel 1306, the lens mount 1304, and/or the mount housing 1308.

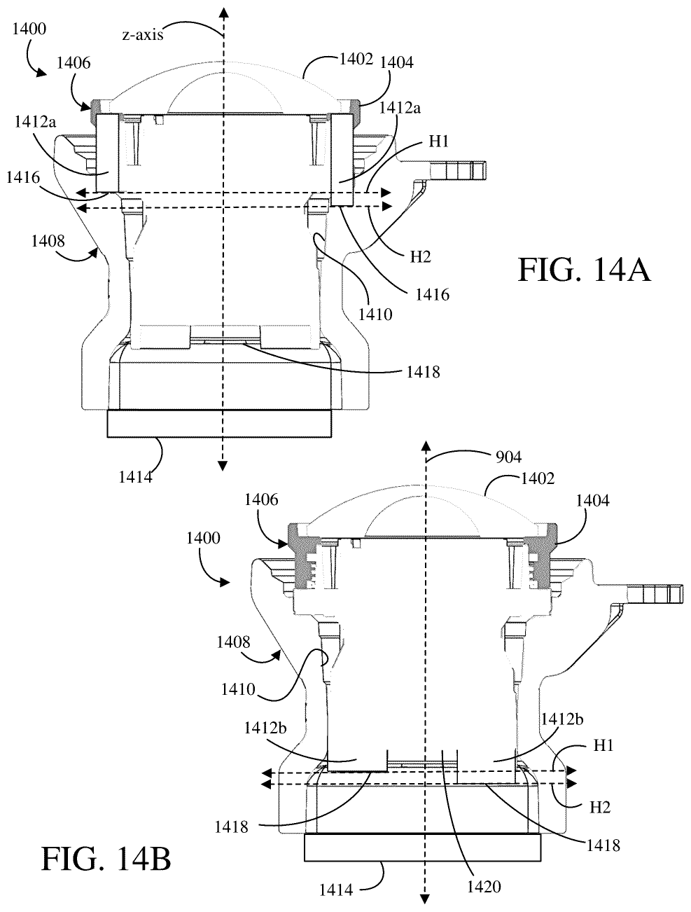

FIG. 14A-B are cross-sectional views of a lens assembly (ISLA) 1400, which by way of example may be a cross-section of an ISLA 1400 along lines XIII-XIII of FIG. 13A, useable with the image capture apparatuses 100, 200, 300, 400 of FIGS. 1A-4. The ISLA 1400 includes an external lens 1402, a lens mount 1404, a lens barrel 1406, and a mount housing 1408. Optionally, the ISLA 1400 may include more than one lens (not shown) such that a desirable focus and field or depth of view is achieved. The mount housing 1408 defines a barrel receptacle 1410 that is configured to receive the lens barrel 1406 such that optical alignment can be achieved or adjusted along the z-axis. The lens barrel 1406 and the barrel receptacle 1410 include mounting interfaces 1412a, 1412b configured to allow the lens barrel 1406 to be rotated relative to the barrel receptacle 1410 such that the lens barrel 1406 moves closer to or further from an image sensor 1414 along the z-axis.

The mounting interface 1412a in FIG. 14A is positioned at flanges 1416 on each of the lens barrel 1406 and the barrel receptacle 1410 that are configured to allow for rotational movement of the mounting interface 1412a. With this configuration, the flanges 1416 can be molded into mirror parts that can easily fit together and allow for an optical adjustment and alignment that is efficient and can be subsequently fixed into position by application of an adhesive (not shown, see, e.g., adhesives 1802, 1902, 2002, 2102 of FIGS. 17A-21B) at any location within the barrel receptacle 1410, such as between or adjacent to the flanges 1416, between a base 1418 and the lens barrel 1406, or at any other appropriate location within the barrel receptacle 1410 that would allow for curing after optical alignment is achieved.

On the other hand, the mounting interface 1412b in FIG. 14B is positioned at the base 1418 of the barrel receptacle 1410 such that the base 1418 controls the position of the mounting interface 1412b along the z-axis. The mounting interface 1412b may be advantageous to adjust the position of the lens barrel 1406 along the z-axis and an adhesive (not shown, see, e.g., adhesives 1802, 1902, 2002, 2102 of FIGS. 17A-21B) can be positioned and/or cured at the base 1418 after optical alignment and be protected from the external environment. Alternatively or in combination, the adhesive (not shown) can be positioned at or adjacent to an opening of the barrel receptacle 1410 such that a cure of the adhesive (not shown) can be made more accessible, such as by UV light or the like. As the mounting interface 1412b is proximate to or adjacent to the image sensor 1414, the mounting interface 1412b has an opening and is configured to avoid obstruction or interference of light or image capture between the external lens 1402 and the image sensor 1414.

The mounting interfaces 1412a, 1412b are configured as a ramp with a substantially helical configuration that slopes between lines H1 and H2. Because of this configuration, the lens barrel 1406 can be rotated at the mounting interfaces 1412a, 1412b and relative to the barrel receptacle 1410 such that optical alignment is achieved. The difference between H1 and H2 may be any distance sufficient to achieve desirable sloping and helical formation of the mounting interfaces 1412a, 1412b. For example, the difference between H1 and H2 may be between 0.5 microns and 20 microns. Additionally, the mounting interfaces 1412a, 1412b may include multiple loops (not shown, one or more, two or more, three or more, four or more, or a plurality of loops) such that a larger distance of adjustment between H1 and H2 can be achieved. In some examples, the mounting interfaces 1412a, 1412b are configured as a contiguous ramp that wraps around the lens barrel 1406 and the barrel receptacle 1410 without any breaks. In other examples, the mounting interfaces 1412a, 1412b may wrap around the lens barrel 1406 and the barrel receptacle 1410 and include one or more steps along the path that provide for a clear support or break between different points between H1 and H2 during optical adjustment. Relative to the z-axis, the mounting interfaces 1412a, 1412b may have a flat configuration (i.e., 90 degrees from the z-axis) or an angled configuration (e.g., between 1 degree and 89 degrees) such that rotation of the lens barrel 1406 and the barrel receptacle is supported. An angled configuration (not shown) may be advantageous to minimize or eliminate any undesirable shifts on the x and y axes (see e.g., FIG. 13A) while the lens barrel 1406 and the barrel receptacle 1410 are rotated at the mounting interfaces 1412a, 1412b.

When using any of the mounting interfaces 1312 of FIGS. 13B-13C or the mounting interfaces 1412a, 1412b of FIGS. 14A-14B, the lens barrels 1306, 1406 may be moved along the z-axis towards or away from the image sensor to an optical distance that is the shortest distance between the external lenses 1302, 1402 and the image sensors 1314, 1414. The optical distance may be predetermined or determined after testing steps described herein. The optical distance may be between about 20 microns and 10 cm. When an optical adjustment is performed, such as by rotation of the lens barrels 1306, 1406 relative to the barrel receptacle 1310, 1410, the lens barrels 1306, 1406 may move along the z-axis by an adjustment distance of about 0.1 microns to about 10 microns such that optical alignment is achieved.

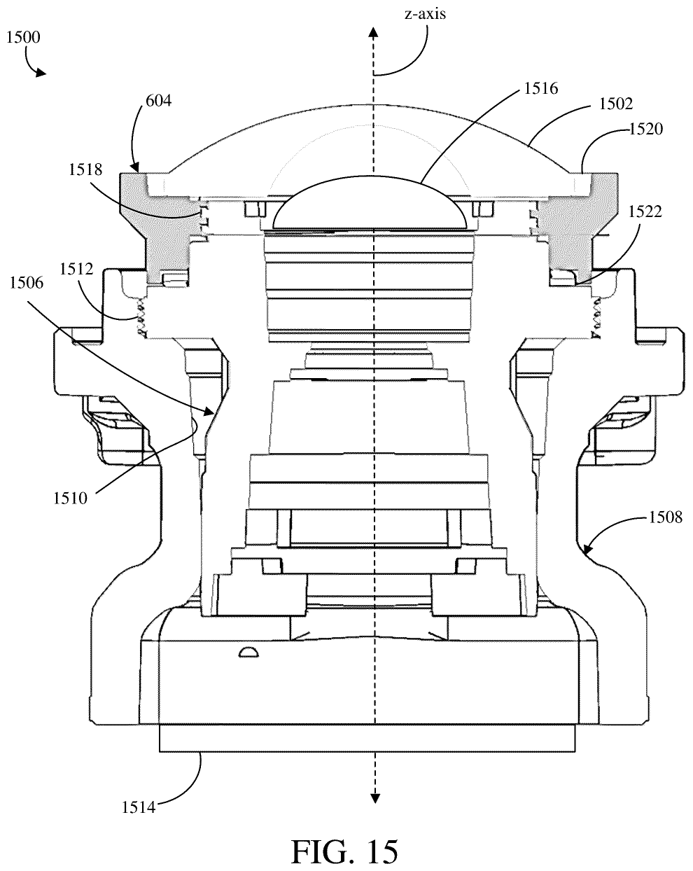

FIG. 15 is a cross-sectional view of a lens assembly (ISLA) 1500. The ISLA 1500 includes a lens 1502 and a lens mount 1504 connected with a lens barrel 1506 that is rotatable relative to a mount housing 1508. The mount housing 1508 defines a barrel receptacle 1510 that is configured to receive and connect with the lens barrel 1506, such as at a mounting interface 1512 that may be configured to make optical adjustments of the lens barrel 1506 relative to an image sensor 1514 along the z-axis.

The lens mount 1504 is connected with the external lens 1502 and configured to move the external lens 1502 relative to the internal lens 1516 such that optical alignment can be achieved. By moving the external and internal lenses 1502, 1516 relative to each other, focus and depth or field of view is improved and can additionally provide for optical adjustments between the external and internal lenses 1502, 1516, if the lens barrel 1506 is not in optical alignment and without having to rotate the mounting interface 1512.

The internal lens 1516 is fixedly connected with the lens barrel 1506 (e.g., through an adhesive or the like), and the external lens 1502 is rotatable connected with the lens barrel 1506 through a lens interface 1518 that is configured to allow rotation between the lens barrel 1506 and the lens mount 1504. The lens interface 1518 may be similar to the mounting interfaces 1312, 1412a, 1412 of FIGS. 13B-14B and allow for movement of the lens mount 1504 relative to the lens barrel 1506 along the z-axis. By having the lens barrel 1506 fixed relative to the barrel receptacle 1510 during rotation of the lens mount 1504, one or more optical adjustments can be made at the lens mount 1504 after the position of the lens barrel 1506 is finalized. Alternatively, the lens interface 1518 and the mounting interface 1512 may be used in sequence or simultaneously to achieve optical alignment through rotation and subsequent movement along any of the x, y, and/or z-axes.

The external lens 1502 and the lens mount 1504 are fixedly connected together through an adhesive 1520 (or a sealant) that is cured. In other words, the external lens 1502 and the lens mount 1504 rotate as one component to make optical alignments and achieve optical alignment. Between flanges of the lens barrel 1506 and the lens mount 1504, a space 1522 defines an area in which the lens mount 1504 may move along the z-axis. The space 1522 may be any distance (e.g., between about 0.1 microns and 10 microns) sufficient to avoid contact of the external and internal lenses 1502, 1516 during rotation of the lens barrel 1506 and the lens mount 1504. In some examples, the lens mount 1504 may be moved by an optical adjustment of about 0.1 microns to about 10 microns such that optical alignment is achieved.

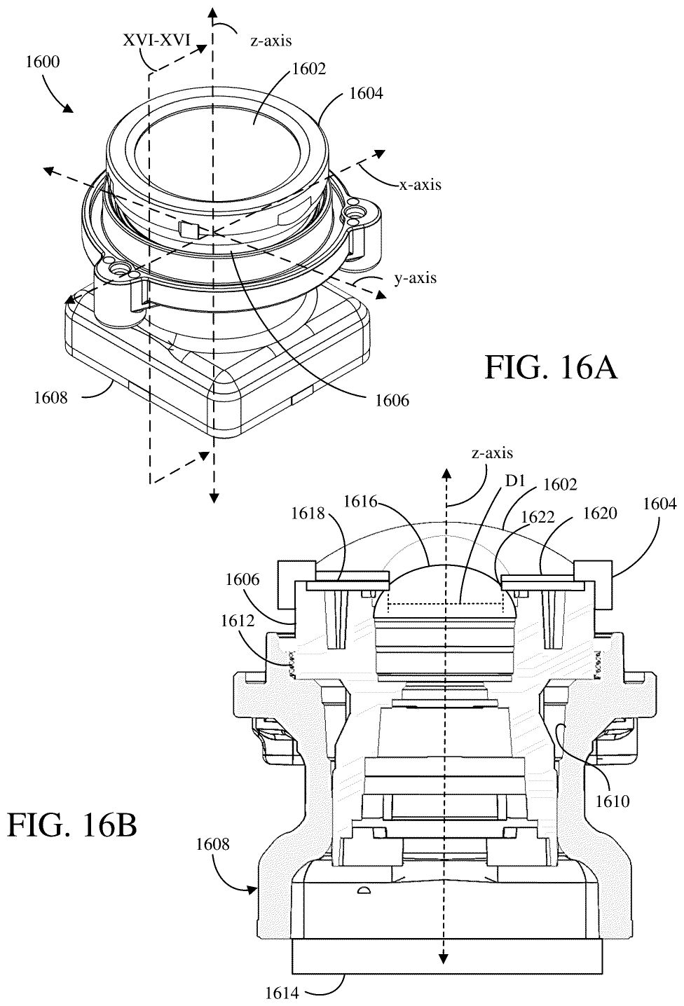

FIGS. 16A-16B are respectively a perspective view and a cross-sectional view of an a lens assembly (ISLA) 1600 along line XVI-XVI. The ISLA 1600 includes an external lens 1602 connected with a lens mount 1604 that is configured to secure the external lens 1602 of a lens barrel 1606. The lens barrel 1606 is connected with a mount housing 1608 within a barrel receptacle 1610 and at a mounting interface 1612.

Within the lens barrel 1606, an internal lens 1616 is connected with the external lens 1602 by a combination of an extension 1618 and an adhesive 1620 that are configured to minimize or prevent movement of the external lens 1602. When assembling, the external lens 1602 is moved into contact with the combination of an extension 1618 and an adhesive 1620 and the lens mount 1604 is used to overlay the external lens 1602 and secure it against the combination of an extension 1618 and an adhesive 1620. When attempting to achieve optical alignment along x, y, and z-axis, the lens mount 1604 and/or the external lens 1602 may be shifted on the combination of an extension 1618 and an adhesive 1620 until optical alignment is achieved. Once optical alignment is achieved, the adhesive 1620 may be cured such that the external and internal lenses 1602, 1616 and the lens mount 1604 are affixed and optically aligned with regard to the lens barrel 1606.

The lens mount 1604 may overlay the external lens 1602 in any desirable manner and may partially hold or connect with the external lens 1602. For example, the lens mount 1604 may first be affixed or connected (e.g., through use of an adhesive) to the external lens 1602 before contacting with the combination of the extension 1618 and the adhesive 1620. Such a configuration may make alignment between the external and internal lenses 1602, 1616 more efficient since connection between the external lens 1602 and the lens mount 1604 may not need adjustment after the external and internal lenses 1602, 1616 are connected. In other examples, the external lens 1602 and the lens mount 1604 are not connected and the lens mount 1604 connects with the lens barrel 1606 and simply overlays the external lens 1602. For example, the lens mount 1604 and the lens barrel 1606 may connect at lateral walls of the lens mount 1604 and the lens barrel 1606 through adhesive free of contact with the external lens 1602, a form fit (e.g., using an elastomer), threads, or any combination thereof.

In some examples, the adhesive 1620 may only be used to achieve optical alignment and no other intervening components may be positioned between the connection of the external and internal lenses 1602, 1616. This may be advantageous to minimize any anomalies or tilt in the extensions 1618 that may cause difficulty in optically aligning the external and internal lenses 1602, 1616. In other examples, an extension 1618 that is optionally malleable such that the lens mount 1604 is used to fixedly connect the external and internal lenses 1602, 1616 into or at optical alignment (optionally in combination with an adhesive on lateral walls of the lens barrel 1606 (not shown)).

Between the extension 1618 and the adhesive 1620, an opening 1622 is defined and has diameter D1 that is sufficiently large (e.g., between about 5 microns and about 5 cm) to avoid obstructing the path of light to the image sensor 1614. On the other hand, the diameter D1 may be sufficiently small to allow the extension 1618 and/or the adhesive 1620 to at least partially contact the internal lens 1616. In other examples, the diameter D1 is sufficiently large to avoid contact between the extension 1618 and/or the adhesive and the internal lens 1616.

FIG. 17A is a cross-sectional view of an a lens assembly (ISLA) 1700 with adhesive 1702. The ISLA 1700 may be useable with the image capture apparatuses 100, 200, 300, 400, of FIGS. 1A-4 or the ISLAs 1300, 1400, 1500, 1600 of FIGS. 13A-16B. The ISLA 1700 includes a platform 1704 configured to support the adhesive 1702 before curing. The platform 1704 may be either a portion of a lens barrel (not shown, see e.g., the lens barrels 1306, 1406, 1506, 1606 of FIGS. 13A-16B) or a portion the barrel receptacle (not shown, see e.g., the barrel receptacles 1310, 1410, 1510, 1610 of FIGS. 13A-16B).

FIG. 17B is a cross-sectional view of the ISLA 1700 with the adhesive 1702 connecting a mounting surface 1706 of the platform 1704 and a connection flange 1710 of a substrate 1708. The substrate 1708 may be configured as a portion of a lens barrel (not shown) or one or more lenses (not shown). The adhesive 1702 is shown as connecting the platform 1704 and the substrate 1708, and when the adhesive 1702 is cured, the adhesive 1702 shrinks due to chemical processes of curing. Subsequently, the platform 1704 and the substrate 1708 move closer together once the adhesive 1702 is cured, which may be referred to as shrinking or shrinkage of the adhesive 1702.

Once the adhesive 1702 is cured and shrinks, the optical alignment of platform 1704 and the substrate 1708 may be impacted by the amount of shrinkage. For example, the adhesive 1702 may shrink along the z-axis, which may be configured as an optical axis, such that the platform 1704 and/or the substrate 1708 may desire adjustment using one of the techniques and apparatuses discussed with regard to FIGS. 6-9. The adhesive 1702 may shrink along the z-axis by between 0.1 microns, 1 micron, or 3 microns and 5 microns, 10 microns, or 20 microns. The adhesive may shrink a percentage along the z-axis, such as about 5 percent or more, about 15 percent or more, about 25 percent or more, or about 50 percent or more, based on the total cross-section of the adhesive 17-2 just before curing.

The amount of shrinkage when the adhesive 1702 is cured may be dependent on the type of adhesive 1702. Any of the adhesives 1702 may utilized to connect the platform 1704 and the substrate 1708. For example, the adhesive 1702 may be one or more of a cyanoacrylate, epoxy resin, polyvinyl acetate, polyurethane, silicone, contact cement, acrylic resin, phenolic resin, or any combination thereof.

The adhesive 1702 may be applied in any form sufficient to connect two components. The adhesive 1702 may be applied as a bead or series of beads that cover most of (i.e., 55 to 90 percent or more of the surface area) of the mounting surface 1706. The adhesive 1702 may be applied as a contiguous stream of adhesive 1702 that covers most of (i.e., 55 to 90 percent or more of the surface area) of the mounting surface 1706. The adhesive 1702 may first be applied by one of the techniques described herein, and once the connection flange 1710 is connected with the adhesive 1702, the adhesive 1702 may deform such that the adhesive covers essentially all of (i.e., 90 to 99 percent or more) of the mounting surface 1706 and/or connection flange 1710 so that a desirable connection is formed. To ensure sufficient deformation of the adhesive 1702 along the mounting surface 1706 and/or connection flange 1710, an external force may be applied to either of the platform 1704 and/or the substrate 1708 such that the a desirable connection is formed at the adhesive 1702.

The adhesives 1702 may be cured by any means sufficient to form an irreversibly cured adhesive 1702. For example, the adhesive 1702 may be cured through pressure, gassing, moisture, ultraviolet light, heat, solvent evaporation, oxygen, or any combination thereof. The curing step of the adhesive may be performed before, during, or after an adjustment step of a mounting interface (not shown, see e.g., the mounting interfaces 1312, 1412, 1512, 1612 of FIGS. 13A-16B). The curing step may be carried out in one or two steps. For example, the curing step may be conducted by partially curing the adhesive 1702, which may optionally induce shrinkage or partial shrinkage of the adhesive 1702, and subsequently conducting an adjustment step of a mounting interface (not shown) before finalizing the cure of the adhesive 1702.

The adhesive 1702 may have viscosity sufficient to remain on the mounting surface 1706 and not drip off before a connecting step with the connection flange 1710 or a curing step that cures the adhesive 1702. The adhesive 1702 may have a viscosity of between about 100 mPa-s, about 500 mPa-s, or about 1000 mPa-s and about 2000 mPa-s, 5000 mPa-s, or 20,000 mPa-s.

FIG. 18A is a cross-sectional view of a lens assembly (ISLA) 1800 with an adhesive 1802 disposed on a platform 1804 at a mounting surface 1806. FIG. 18B is a cross-sectional view of the ISLA 1800 with the adhesive 1802 connecting the platform 1804 and a substrate 1808 at the mounting surface 1806 and a connection flange 1810 of the substrate 1808. The a ISLA 1800 may be useable with the image capture apparatuses 100, 200, 300, 400 of FIGS. 1A-4 and may be similar to the ISLAs 1300, 1400, 1500, 1600, 1700 of FIGS. 13A-16B. The adhesive 1802, the platform 1804, the mounting surface 1806, the substrate 1808, and the connection flange 1810 may be similar to the adhesive 1702, the platform 1704, the mounting surface 1706, the substrate 1708, and the connection flange 1710 of FIGS. 17A-17B.

The mounting surface 1806 may have an angle θ relative to a base 1812 of the platform 1804 sufficient to retain the adhesive 1802 and to reduce vertical shrinkage of the substrate 1808 along a z-axis after curing the adhesive 1802. The shrinkage value S of the substrate 1808 on the mounting surface 1806 can be dependent on the angle θ relative to the base 1812 and the shrinkage value A of the adhesive 1802. Specifically, the shrinkage value S may be expressed by the following formula:

Shrinkage Value S=cos(angle θ)×Shrinkage Value A

The shrinkage value A may be measured by determining shrinkage of the adhesive A along the z-axis when the mounting surface 1806 has a 0 degree angle θ (i.e., the mounting surface 1806 is not angled) relative to the base 1812. The shrinkage value A may be expressed as an average value of shrinking or as a margin of error (i.e., plus or minus the shrinkage value A) of shrinking. The shrinkage value A may be about 0.5 microns, about 1 micron, or about 2 microns to about 4 microns, about 6 microns, or about 10 microns. The angle θ may be any angle relative to the base 1812 sufficient to achieve a desirable shrinkage value S. For example, the angle θ may be 0 degrees, 15 degrees, or 30 degrees to 45 degrees, 60 degrees, or 90 degrees. Using the above formula, the Shrinkage Value S may be about 0.1 microns, about 0.5 micron, or about 1 microns to about 2 microns, about 4 microns, or about 5 microns. Generally, shrinkage may occur during curing and shrink consistent with the direction of gravitation forces.

On the mounting surface 1806 may have a surface roughness sufficient to retain the adhesive 1802 without flowing (e.g., from gravitation forces) onto the base 1812 before connection of the connection flange 1810 or partial cure of the adhesive 1802. The surface roughness may be 0.1 microns to 10 microns.

The connection flange 1810 of the substrate 1808 may be pressed into the adhesive 1802 before any curing or after a partial cure of the adhesive 1802. After pressing, the connection flange 1810 may deform and distribute the adhesive 1002 onto essentially all (i.e., about 90 to 99 percent or more of the total surface) of the mounting surface 1806 and/or the connection flange 1810. The connection flange 1810 may be an integral and/or continuous part of the substrate 1808, such as a cut portion of a lens (not shown, see e.g., the external, internal, and focal lenses 1302, 1316, 1318, 1402, 1502, 1516, 1602, 1616 of FIGS. 13A-16B). The connection flange 1810 may be a separate part of the substrate 1808 that is connected with (e.g., through another adhesive (not shown), heat fusion, fasteners, etc.) the substrate 1808, such as in an example of a housing (not shown) of a lens barrel (e.g., not shown, see e.g., the lens barrels 1306, 1406, 1506, 1606 of FIGS. 13A-16B). The connection flange 1810 may have an angle α relative to the base that is an opposing angle of angle θ. In some examples, the angle α may have an angle that is not opposing and is substantially different than the angle θ of the mounting surface 1806. Opposing angles as used herein are either 0 degrees or have a positive (i.e., the angle θ) and negative (i.e., angle α) shift from 0 degrees that is the same. For example, the angle α may be 0 degrees, 345 degrees, or 330 degrees to 315 degrees, 300 degrees, or 270 degrees.

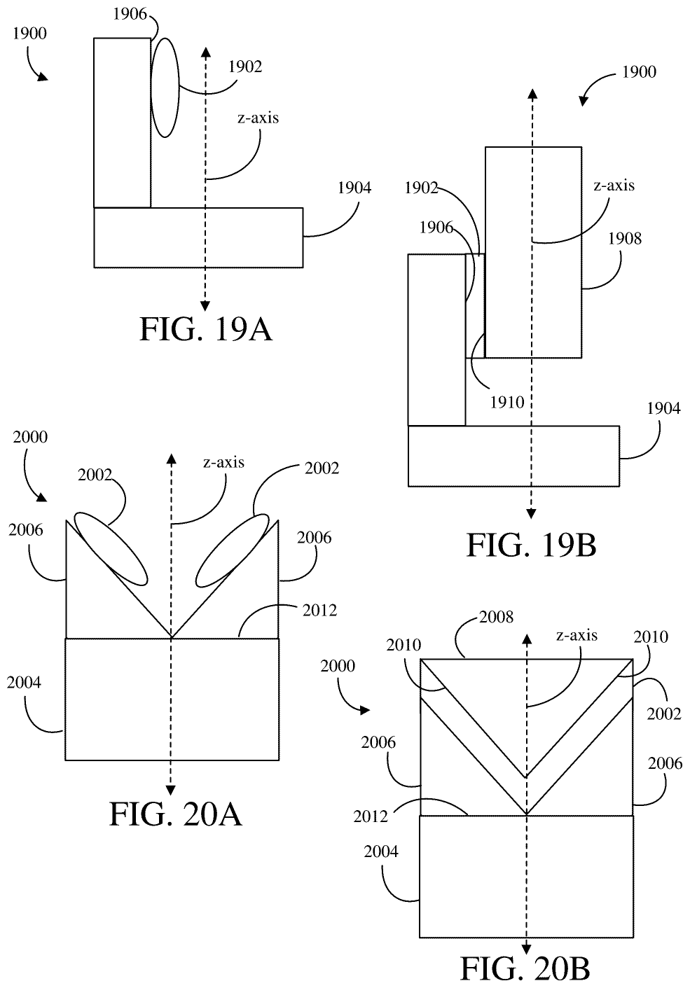

FIG. 19A is a cross-sectional view of a lens assembly (ISLA) 1900 having an adhesive 1902 disposed on a platform 1904 that includes a mounting surface 1906 that is essentially vertical (i.e., about 80 to 90 degrees) relative to the platform 1904. FIG. 19B is a cross-sectional view of the ISLA 1900 with the platform 1904 connected with a substrate 1908 through the adhesive 1902 at the mounting surface 1906 and a connection flange 1910. Relative to a base 1912 of the platform 1904, the mounting surface 1906 and the connection flange 1910 are essentially vertical (i.e., about 80 to 90 degrees) so that minimal shrinkage occurs of the substrate 1908 to the platform 1904 via the adhesive 1902 cure. The ISLA 1900 may be similar to the ISLAs 1300, 1400, 1500, 1600, 1700, 1800 and useable with the image capture apparatuses 100, 200, 300, 400 of FIGS. 1A-4. The adhesive 1902, the platform 1904, the mounting surface 1906, the substrate 1908, the connection flange 1910, and the base 1912 may be similar to the adhesive 1702, 1802, the platform 1704, 1804, the mounting surface 1706, 1806, the substrate 1708, 1808, the connection flange 1710, 1810, and the base 1712 of FIGS. 17A-18B.

As discussed herein, the shrinkage value A of the adhesive 1902 is the amount that the adhesive 1902 shrinks along a z-axis. Shrinkage as described herein with regard to the adhesive 1902 may refer to deformation of the adhesive 1902 due to gravity (or another external force) during full or partial curing. The z-axis is defined as an axis that is perpendicular relative to the base 1912. The z-axis may also be referred to as an optical axis that is aligned with an image sensor (not shown, e.g., the image sensors 1314, 1414, 1514, 1614 of FIGS. 13A-16B) and one or more lenses (not shown, see e.g., the external, internal, and focal lenses 1302, 1316, 1318, 1402, 1502, 1516, 1602, 1616 of FIGS. 13A-16B) of a lens barrel (not shown, see e.g., the lens barrels 1306, 1406, 1506, 1606 of FIGS. 13A-16B). The z-axis and/or the optical axis described herein may be used as a reference for correcting position of one or more of the substrates 1908, the platforms 1904, another component (e.g., a lens barrel, a barrel receptacle, a mounting interface, a lens, or a combination thereof), or a combination thereof.

The mounting surface 1906 and the connection flange 1910 in an essentially vertical configuration (i.e., between 80 and 90 degrees) is advantageous because a lens shrinkage S (see above formula in regard to FIGS. 11A-11B) is zero or essentially zero because the angel is 90 degrees or close to 90 degrees and the cosine of 90 degrees is zero. With the shrinkage value S being zero, the adhesive 1902 can be set at a desirable location on the mounting surface 1906 and connected with connection flange 1910 such that the no movement of the substrate occurs during curing. In the case of optical alignment between a lens (not shown) and an image sensor (not shown), the essentially vertical configuration allows for precise alignment and connectivity, without movement along the z-axis of the adhesive 1902 after curing.

Where the adhesive 1902 has a viscosity that is sufficiently high such that the adhesive 1902 has the potential to run along the mounting surface 1906 to the base 1912 due to gravity, the adhesive 1902 may be at least partially cured such that the viscosity of the adhesive 1902 is increased. Any type of multi-step curing process may be conducted on the adhesive 1902 to increase viscosity of the adhesive 1902 before final cure. For example, the adhesive 1902 may be partially cured through application of UV radiation or heat to increase viscosity, and in a second step, such as through pressure, moisture, gassing, or oxygen, to finalize the cure. In some examples, the adhesive 1902 may have a viscosity sufficiently high before curing that allows for application on an essentially vertical configuration of mounting surface 1906 and connection flange 1910. Any type of curing described herein or well known in the art may be utilized on the adhesive 1902 in a multi-step process to achieve adhesion between the mounting surface 1906 and the connection flange 1910.

FIG. 20A is a cross-sectional view of a lens assembly (ISLA) 2000 illustrates a configuration of the adhesive 2002 applied to a platform 2004 having mounting surfaces 2006 that each have an angle (e.g., such as angle θ of FIG. 18B measured from a base 1812) that is the same. FIG. 20B is a cross-sectional view of the ISLA 2000 with the platform 2004 connected with a substrate 2008 at the adhesive 2002 sandwiched between the mounting surface 2006 and a connection flange 2010. Between the connection flange 2010 and the mounting surface 2006, a z-axis is defined that is perpendicular relative to a base 2012 of the platform 2004. In some examples, the base 2012 defines a boundary between the mounting surface 2006 and the platform 2004. In other examples, the base 2012 is a surface that is a defined x and y axes (not shown) that are perpendicular relative z-axis and parallel relative to another planar surface of the ISLA 2000.

The ISLA 2000 may be similar to the ISLAs 1300, 1400, 1500, 1600, 1700, 1800, 1900 of FIGS. 13A-19B and useable with the image capture apparatus 100, 200, 300, 400 of FIGS. 1A-4. The adhesive 2002, the platform 2004, the mounting surface 2006, the substrate 2008, the connection flange 2010, and the base 2012 may be similar to the adhesive 1702, 1802, 1902, the platform 1704, 1804, 1904, the mounting surface 1706, 1806, 1906, the substrate 1708, 1808, 1908, the connection flange 1710, 1810, 1910, and the base 1712, 1812 of FIGS. 17A-19B.

In this example, the connection flange 2010 includes a pair of connection surfaces that are configured to interface with a pair of supporting surfaces of the mounting surface 2006. The amount of the adhesive 2002 may be selected such that a desirable cross-sectional height of the adhesive 2002 is achieved before or after full or partial curing between the mounting surface 2006 and the connection flange 2010. The cross-sectional height is measured from the closest surfaces between connection flange 2010 and the mounting surface 2006. Alternatively, where the connection flange 2010 is not yet contacted with the adhesive 2002 (i.e., FIG. 20A), the cross-sectional height of the adhesive 2002 may be measured from the furthest external and essentially parallel surface of the adhesive 2002 relative to the mounting surface 2006. The cross-sectional height of the adhesive 2002 may be essentially the same (i.e., within 1 to 10 percent of the height of another portion) along the entire cross-sectional height of the adhesive 2002.

The amount of adhesive 2002 applied to the mounting surface 2006 may be any amount desirable to achieve minimal z-axis shrinkage after curing. The amount of adhesive 2002 may be an amount sufficient to cover all or substantially all of the mounting surface 2006 and/or the connection flange 2010. The amount of adhesive 2002 and/or an angle (e.g., the angle θ of FIG. 18B) of the mounting surface 2006 or an angle (e.g., the angle α of FIG. 18B) relative to the base 2012 may be applied such that shrinkage and overflow of adhesive are controlled simultaneously. For example, an amount of adhesive 2002 may be applied on the mounting surface 2006 in two or more places with an expectation that the adhesive will flow or be spread across a surface area of the mounting surface 2006 as the connection flange 2010 of the substrate is moved along the z-axis to connect with the platform 2004.

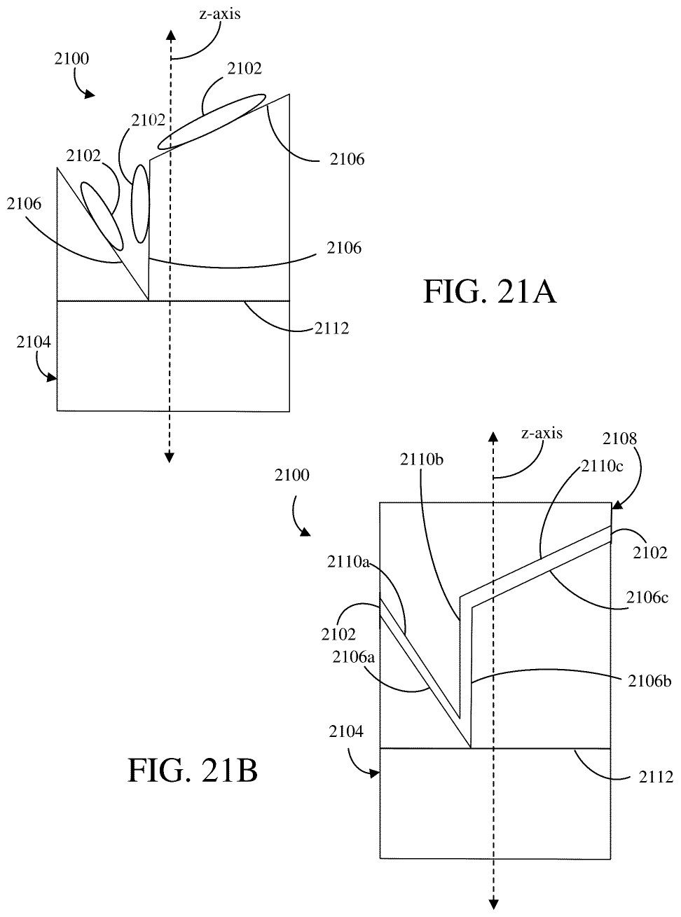

FIGS. 21A-21B are cross-sectional views of a lens assembly (ISLA) 2100. The ISLA 2100 includes adhesives 2102 disposed on a platform 2104 on mounting surfaces 2106a, 2106b, 2106c that are each have a different mounting angle (e.g., the angle θ of FIG. 18B) configured to connect with a substrate 2108 during optical alignment along a z-axis. Opposing the mounting surfaces 2106a, 2106b, 2106c, connection flanges 2110a, 2110b, 2110c have a connection angle (e.g., the angle α of FIG. 18B) that corresponds to the mounting angle of the mounting surfaces 2106a, 2106b, 2106b such that the substrate 2108 and the platform 2104 align along the z-axis and x and y-axes after a cure of the adhesives 2102. Each of the mounting surfaces 2106a, 2106b, 2106c has a different mounting angle such that each of the mounting angles can be used together or separately to achieve optical alignment and avoid overflow of the adhesive 2102. For example, a portion of the adhesive 2102 may only be applied to the mounting surface 2106c, with the expectation that some of the adhesive 2102 will flow into the mounting surfaces 2106b, 2106a before curing due to contact between the platform 2104 and the substrate 2108 and/or gravitational forces. The mounting angles may be arranged such that shrinkage is minimized during curing of the adhesive 2102 and adhesion is improved between the substrate 2108 and the platform 2104.

The ISLA 2100 may be similar to the ISLAs 1300, 1400, 1500, 1600, 1700, 1800, 1900, 2000 of FIGS. 13A-20B and useable with the image capture apparatuses 100, 200, 300, 400 of FIGS. 1A-4. The adhesive 2102, the platform 2104, the mounting surface 2106, the substrate 2108, the connection flange 2110, and the base 2112 may be similar to the adhesives 1702, 1802, 1902, 2002 the platforms 1704, 1804, 1904, 2004, the mounting surfaces 1706, 1806, 1906, 2006, the substrates 1708, 1808, 1908, 2008, the connection flanges 1710, 1810, 1910, 2010, and the base 1712, 1812, 2012 of FIGS. 17A-19B.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An image capture apparatus, comprising:
an image sensor and lens assembly (ISLA) comprising:
an image sensor;
a lens mount connecting the ISLA within the image capture apparatus, the lens mount extending away from the image sensor;
a lens barrel in communication with the lens mount;
barrel lenses located within the lens barrel;
a lens sub-barrel that is movably connected to the lens barrel, the lens mount, or both; and
a sub-barrel lens located within the lens sub-barrel.

2. The image capture apparatus of claim 1, wherein the lens sub-barrel is movable along an optical axis of the ISLA to adjust light directed to the image sensor.

3. The image capture apparatus of claim 2, wherein the lens sub-barrel is rotatable about the optical axis to move the lens sub-barrel along the optical axis.

4. The image capture apparatus of claim 1, wherein an airgap is located between a rear side of the sub-barrel lens within the lens sub-barrel and a forward side of a first of the barrel lenses located within the lens barrel, and wherein moving the lens sub-barrel along an optical axis of the ISLA changes a length of the airgap.

5. The image capture apparatus of claim 1, wherein the sub-barrel lens within the lens sub-barrel is two or more sub-barrel lenses.

6. The image capture apparatus of claim 1, wherein the lens barrel is movably connected to the lens mount.

7. The image capture apparatus of claim 6, wherein the barrel lenses are five or more barrel lenses.

8. An image capture apparatus, comprising:
an image sensor and lens assembly (ISLA) comprising:
an image sensor;
an optical axis that extends through the ISLA to the image sensor;
a lens sub-barrel extending away from the image sensor along the optical axis;
a lens barrel located between the image sensor and the lens sub-barrel, the lens barrel extending away from the image sensor along the optical axis;
barrel lenses located within the lens barrel;
one or more sub-barrel lenses located within the lens sub-barrel; and
an air gap located between the barrel lenses and the one or more sub-barrel lenses;
wherein the air gap is adjustable by moving the lens sub-barrel along the optical axis relative to the lens barrel.

9. The image capture apparatus of claim 8, wherein moving the lens sub-barrel along the optical axis moves light extending through the optical axis laterally relative to the optical axis.

10. The image capture apparatus of claim 9, wherein a sensitivity to z tolerance of the one or more sub-barrel lenses is about 2× or more and about 10× or less.

11. The image capture apparatus of claim 10, wherein the sensitivity to z tolerance is a distance the lens sub-barrel moves in a z-direction to a distance the light moves relative to the optical axis.

12. The image capture apparatus of claim 8, further comprising:
a lens mount located between and connecting the image sensor to the lens barrel, and wherein the lens mount is movable relative to the image sensor, the lens mount, or both.

13. The image capture apparatus of claim 12, wherein the one or more sub-barrel lenses are a single lens that forms a forward surface of the ISLA.

14. The image capture apparatus of claim 8, further comprising:
lens barrel outer fasteners located on the lens barrel and
sub-barrel fasteners located on the lens sub-barrel, wherein the lens barrel outer fasteners connect the lens barrel to the sub-barrel fasteners of the lens sub-barrel.

15. The image capture apparatus of claim 14, further comprising:
a connecting agent located between and locking the sub-barrel fasteners to the lens barrel outer fasteners so that the lens sub-barrel is prevented from moving relative to the lens barrel.

16. The image capture apparatus of claim 15, wherein the connecting agent is an ultraviolet light cure adhesive.

17. A method comprising:
installing barrel lenses within a lens barrel;
installing one or more sub-barrel lenses within a lens sub-barrel;
connecting the lens sub-barrel to the lens barrel;
connecting an image sensor to the lens barrel and the lens sub-barrel, wherein the image sensor, the lens barrel, and the lens sub-barrel are aligned along an optical axis; and
moving the lens sub-barrel relative to the lens barrel with respect to the optical axis to change a dimension of an air gap between the barrel lenses and the one or more sub-barrel lenses.

18. The method of claim 17, further comprising:
applying a connecting agent to the lens sub-barrel, the lens barrel, or both before, during, or after the lens sub-barrel and the lens barrel are connected together.

19. The method of claim 18, further comprising:
activating the connecting agent to lock the lens sub-barrel to the lens barrel.

20. The method of claim 17, further comprising:
determining a focus of light relative to the image sensor.
